(19) United States
(12) Patent Application Publication
(10) Pub. No.: US 2026/0362178 A1
(43) Pub. Date: Nov. 12, 2026

(54) SELF-OPTIMIZING WIRELESS SYSTEM FOR DATA CENTER COMMUNICATIONS

(71) Applicant: MELLANOX TECHNOLOGIES, LTD., Yokneam (IL)

(72) Inventors: Aleksey Dyskin, Haifa (IL); Elad Mentovich, Tel Aviv (IL)

(21) Appl. No.: 19/200,597

(22) Filed: May 6, 2025

(51) Int. Cl. H04W 24/08; H04B 7/06; H04L 41/16; H04W 16/28

(52) U.S. Cl. CPC H04W 24/08; H04B 7/0617; H04L 41/16; H04W 16/28

(57) ABSTRACT

A device and method for improving wireless communications in data center environments are disclosed. The device may comprise one or more circuits configured to receive wireless performance parameters associated with communications between data center components and input these parameters into a machine-learning model trained to determine wireless parameter adjustments for a data center configuration. The circuits may receive, as output from the machine-learning model, wireless communication adjustment parameters and update a configuration table with these parameters. The machine-learning model may analyze metrics including signal-to-noise ratio, bit error rate, latency, throughput, and interference levels to generate optimized wireless parameters such as modulation schemes, frequency allocations, bandwidth settings, and transmission power levels. This self-optimizing wireless communication system enables maintenance-free data center interconnects that automatically adapt to changing network conditions and workload requirements without manual intervention.

### FIELD OF THE DISCLOSURE

The present disclosure is generally directed toward networking and, in particular, toward networking devices and methods of operating the same.

### BACKGROUND

Data center architecture continues to evolve toward higher densities and increasingly diverse workloads, making network connectivity between servers, switches, and storage devices a critical operational component. Traditional data center networking relies primarily on physical cabling infrastructure, which presents challenges in terms of installation complexity, maintenance requirements, and physical space constraints. Wireless communication technologies present an alternative approach that could potentially reduce dependency on fixed cabling. In conventional wireless networking implementations, parameters such as transmit power, frequency channel assignment, and modulation schemes are configured to establish reliable connections. These parameters impact performance characteristics, including throughput, latency, and error rates. As wireless technologies advance into millimeter wave and terahertz frequency ranges, they offer increasing bandwidth potential that could support the demanding communication requirements of modern data center applications.

### GENERAL DESCRIPTION

In accordance with at least some aspects of the present disclosure, methods and systems are directed to self-optimizing wireless communication systems in data center environments. IN some aspects, one or more circuits to receive wireless performance parameters associated with communications between a plurality of data center components are described. The one or more circuits may input the wireless performance parameters into a machine-learning model trained to determine wireless parameter adjustments for a data center configuration, receive wireless communication adjustment parameters as output from the machine-learning model, and update a configuration table with these wireless communication adjustment parameters.

In some implementations, the wireless performance parameters include signal-to-noise ratio, bit error rate, latency, throughput, and interference levels, which are aggregated from multiple wireless links within the data center. The machine-learning model may be implemented as a neural network trained on data specific to the data center configuration.

The wireless communication adjustment parameters generated by the model may include modulation scheme adjustments, frequency allocations, bandwidth allocations, transmission power levels, and beam steering parameters. For workloads with different priority levels, the system can implement higher-order modulation schemes (such as 64-QAM through 4096-QAM) for high-priority workloads and lower-order modulation schemes (such as QPSK, 8-QAM, or 16-QAM) for low-priority workloads.

The apparatus may further identify critical and non-critical data traffic based on workload information and prioritize the critical traffic, particularly during periods of network congestion or to meet power consumption requirements. The configuration table maintains mappings between data center components and their corresponding wireless communication parameters, which are distributed to wireless transceivers for implementation.

Additional aspects enable the machine-learning model to determine interference patterns based on the physical layout of data center components and generate beamforming parameters to improve signal isolation. The system can monitor communication patterns between component pairs, identify frequently communicating components, and adjust wireless parameters accordingly. The configuration table may maintain separate parameter settings for different communication scopes including pod-to-pod, rack-to-rack, and tray-to-tray communications.

Example aspects of the present disclosure provide an apparatus. In some aspects, the apparatus may comprise one or more circuits to: receive wireless performance parameters associated with communications between a plurality of data center components; input the wireless performance parameters into a machine-learning model trained to determine wireless parameter adjustments for a data center configuration; receive, as output from the machine-learning model, one or more wireless communication adjustment parameters; and update a configuration table with the one or more wireless communication adjustment parameters.

Aspects include wherein the wireless performance parameters comprise at least one of: signal-to-noise ratio; bit error rate; latency; throughput; or interference levels; and the one or more circuits are further to aggregate the wireless performance parameters from multiple wireless links within the data center.

Aspects include wherein the machine-learning model comprises a neural network trained on training data including wireless performance parameters specific to the data center configuration.

Aspects include wherein the one or more wireless communication adjustment parameters comprise at least one of: modulation scheme adjustments; frequency allocations; bandwidth allocations; transmission power levels; or beam steering parameters.

Aspects include wherein the modulation scheme adjustments comprise instructions to implement higher order modulation schemes for high priority workloads and lower order modulation schemes for low priority workloads, wherein the higher order modulation schemes comprise at least one of 64-QAM, 128-QAM, 256-QAM, 1024-QAM, 2048-QAM, or 4096-QAM, and wherein the lower order modulation schemes comprise at least one of QPSK, 8-QAM, or 16-QAM.

Aspects include wherein the one or more circuits are further to: receive workload information associated with the plurality of data center components; identify critical data traffic and non-critical data traffic based on the received workload information; and prioritize the critical data traffic over the non-critical data traffic based on periods of network congestion or to meet power consumption requirements.

Aspects include wherein the one or more circuits are further configured to: monitor workload conditions among the plurality of data center components, the workload conditions comprising at least one of traffic volume, processing utilization, or application priority data; identify workload priorities based on the monitored workload conditions; and adjust bandwidth allocations for one or more wireless links according to the identified workload priorities, wherein bandwidth for higher-priority workloads is increased and bandwidth for lower-priority workloads is decreased.

Aspects include wherein the configuration table comprises entries that map data center components to corresponding wireless communication adjustment parameters.

Aspects include wherein the one or more circuits are further to: distribute the configuration table to wireless transceivers within the data center; and cause the wireless transceivers to implement the one or more wireless communication adjustment parameters.

Aspects include wherein the machine-learning model is further configured to: determine interference patterns in the data center based on a physical layout of the plurality of data center components; and generate corresponding beamforming parameters for improving signal isolation.

Aspects include wherein the one or more circuits are further to: generate an interference metric for each transceiver by analyzing overlapping frequency bands; determine a beam steering angle for each transceiver; and update the configuration table with beamforming parameters that reduce interference across a wireless network of the data center.

Aspects include wherein the one or more circuits are further to maintain separate wireless communication adjustment parameters in the configuration table for different categories of data center traffic including at least two of: control and management traffic, data backup traffic, or real-time application traffic.

Aspects include wherein the plurality of data center components comprises: rack-mounted servers; storage devices; and wireless-enabled network switches.

Aspects include wherein the one or more circuits are further to: monitor communication patterns between data center component pairs; identify frequently communicating data center components; and adjust wireless communication adjustment parameters based on being identified as frequently communication data center components.

Aspects include wherein the configuration table maintains separate parameter settings for: pod-to-pod communications; rack-to-rack communications; and tray-to-tray communications within racks.

Aspects include wherein the one or more circuits are further to: detect changes in physical component locations; obtain updated wireless performance parameters based on the updated physical component locations; and propagate wireless communication adjustment parameters to one or more data center components.

Aspects include wherein the one or more circuits are further to: monitor the wireless performance parameters in real-time; and automatically adjust at least one of signal strength, frequency allocations, or modulation schemes for the plurality of wireless links based on the monitored wireless performance parameters.

Example aspects of the present disclosure provide a system. In some aspects, the system comprises a plurality of wireless communication interfaces to facilitate communications between a plurality of data center components; a performance monitoring module to receive wireless performance parameters associated with the communications between the plurality of data center components; a machine-learning model trained to determine wireless communication adjustment parameters for a data center configuration; and a configuration management module to update a configuration table with one or more wireless communication adjustment parameters received from the machine-learning model, wherein the plurality of wireless communication interfaces implement the wireless communication adjustment parameters based on the configuration table.

Aspects include wherein the configuration management module is further to: detect changes in physical component locations within the data center; obtain updated wireless performance parameters based on distances between the plurality of data center components after the detected changes in physical component locations within the data center; and propagate updated wireless communication adjustment parameters to one or more of the plurality of data center components based on the updated wireless performance parameters.

Aspects include wherein the machine-learning model is further to: analyze historical patterns of workload fluctuations in the data center; identify correlations between specific workload types and wireless communication parameters; and determine future wireless resource requirements based on scheduled workloads, wherein the configuration management module is further to preemptively update the configuration table based on the determined future wireless resource requirements before the scheduled workloads begin execution.

Example aspects of the present disclosure provide a device. The device may comprise a monitoring interface to receive wireless performance metrics from a plurality of wireless links between data center components in a data center; a workload analysis circuit to: identify different categories of data traffic based on workload characteristics; determine priority levels for the different categories of data traffic; and map the priority levels to wireless resource requirements; a parameter engine to: analyze the received wireless performance metrics and the wireless resource requirements; determine wireless communication parameters for each wireless link of the plurality of wireless links based on the analysis of the received wireless performance metrics and the wireless resource requirements; and generate implementation instructions for the wireless communication parameters; and a distribution interface to transmit the implementation instructions to wireless communication devices associated with the plurality of wireless links.

Additional features and advantages are described herein and will be apparent from the following Detailed Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 depicts an example data center environment, in accordance with at least some aspects of the present disclosure;

FIG. 2A depicts a block diagram of a wireless communication control system, in accordance with at least some aspects of the present disclosure;

FIG. 2B depicts a block diagram of a wireless communication control system, in accordance with at least some aspects of the present disclosure;

FIG. 3A depicts a ‘machine-learning training framework used to generate a trained model based on historical wireless performance data, in accordance with at least some aspects of the present disclosure;

FIG. 3B depicts a neural network-based inference model architecture, in accordance with at least some aspects of the present disclosure;

FIG. 4A depicts a network environment comprising interconnect devices, processing nodes, and client devices, in accordance with at least some aspects of the present disclosure;

FIG. 4B depicts a block diagram of an interconnect device, in accordance with at least some aspects of the present disclosure;

FIG. 5A depicts a workload classification and routing table, in accordance with at least some aspects of the present disclosure;

FIG. 5B depicts a link configuration table, in accordance with at least some aspects of the present disclosure;

FIG. 5C depicts a wireless link monitoring table, in accordance with at least some aspects of the present disclosure;

FIG. 6A depicts a flowchart of a method for autonomously managing wireless communication parameters in a data center using a machine-learning model, in accordance with at least some aspects of the present disclosure;

FIG. 6B depicts additional details of the configuration update procedure, in accordance with at least some aspects of the present disclosure; and

FIG. 6C depicts a flowchart for adjusting wireless parameters, in accordance with at least some aspects of the present disclosure.

FIGS. 6D and 6E depict a flowchart for generating implementation instructions for wireless communication parameters, in accordance with at least some aspects of the present disclosure;

FIG. 7 illustrates a block diagram of a system that includes switching circuitry positioned between first and second sets of devices, in accordance with at least one embodiment;

FIG. 8 illustrates a block diagram of an example system, in accordance with at least one embodiment; and

FIG. 9 illustrates an example data center, in accordance with at least one embodiment.

Like reference numbers and designations in the various drawings indicate like elements.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not to be deemed “material.”

The terms “determine,” “calculate,” and “compute,” and variations thereof, as used herein, are used interchangeably, and include any appropriate type of methodology, process, operation, or technique.

Various aspects of the present disclosure will be described herein with reference to drawings that are schematic illustrations of idealized configurations. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

Aspects of the present disclosure provide apparatuses, methods, processing systems, and computer-readable mediums for self-optimizing wireless communication systems in data center environments.

Modern data centers rely on complex network infrastructure to facilitate communication between servers, storage devices, and networking equipment. As data center density increases and workloads become more diverse, ensuring optimal connectivity presents challenges. Aspects of the present disclosure are directed to a ‘machine-learning-driven approach to wireless communication optimization that adjusts parameters based on real-time performance metrics, eliminating the need for manual intervention while maintaining peak performance across varying operational conditions.

Traditional data center networking faces several technical problems. First, manual configuration of wireless parameters is time-consuming and often results in suboptimal performance as conditions change. Second, static configurations do not adapt to dynamic workload shifts or interference patterns that emerge in dense computing environments. Third, balancing competing requirements such as throughput, latency, and power efficiency across numerous wireless links becomes complex as data centers scale. Finally, identifying and resolving wireless performance bottlenecks may require specialized expertise and may introduce maintenance overhead that impacts operational efficiency. As data centers utilize more hardware and process heavier workloads, relying on fixed and/or manually tuned wireless settings can lead to congestion and wasted bandwidth.

At least one technical solution described by aspects of the present disclosure utilizes a system that monitors wireless performance parameters including signal-to-noise ratios, throughput metrics, and/or interference levels across data center components. The parameters are fed into a machine-learning model that analyzes the data and generates optimized wireless configuration parameters. If the machine-learning model spots a risk of slowdowns or interference, the model can update a configuration table with new parameters, like frequency or bandwidth allocations, which are then sent to wireless transceivers in the data center (e.g., to trays, servers, pods, etc.). The system then updates configuration tables with these parameters and distributes them to the appropriate wireless transceivers. Additional technical solutions include workload-aware resource allocation that prioritizes critical traffic, interference pattern analysis for optimized beamforming, and predictive parameter adjustment based on historical performance data. This solution improves throughput, reduces latency, and helps avoid bottlenecks by matching network resources to traffic conditions.

Such technical approaches as described above provide several advantages. For example, by enabling real-time, autonomous optimization of wireless parameters, the system eliminates or reduces maintenance overhead while improving overall network performance. The machine-learning model's ability to identify subtle patterns in wireless performance data allows for more efficient resource allocation than may be possible with manual configuration or rule-based systems. Workload-aware prioritization ensures some applications maintain performance levels while optimizing power consumption for less demanding tasks. Additionally, the system's adaptability to physical changes in the data center environment reduces reconfiguration costs when equipment is added, removed, or relocated. Together, these technical effects may improve data center operational efficiency, reduce energy consumption, and enhance network reliability without increasing administrative burden.

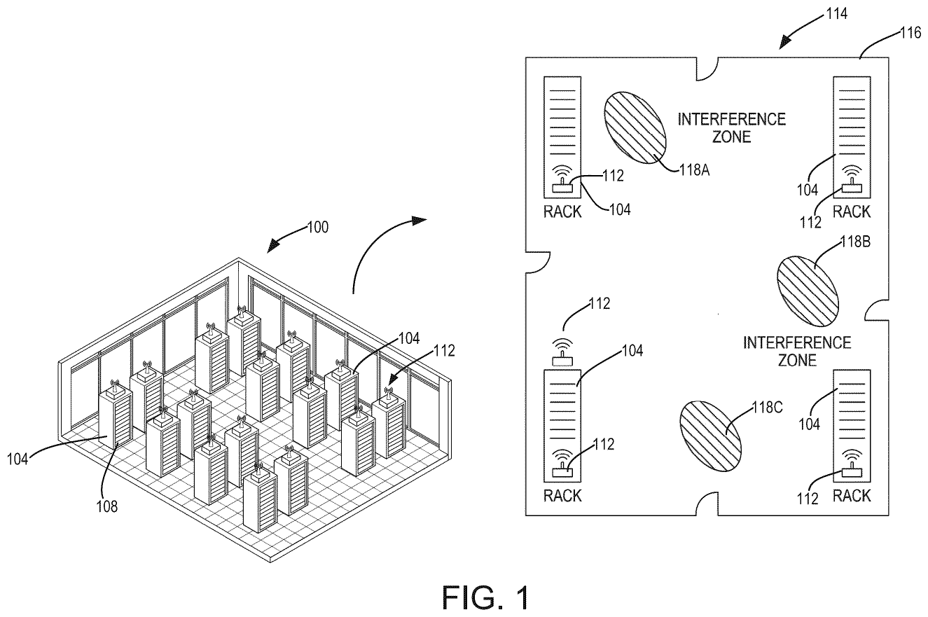

FIG. 1 illustrates an example data center environment 100 incorporating a self-optimizing wireless communication system in accordance with aspects of the present disclosure. The example data center environment 100 may include a plurality of racks 104 arranged in an organized array (or other organization) to facilitate access, cooling, and maintenance. Each rack 104 may house one or more computing devices 108, comprising servers, storage nodes, network switches, routers, or other data processing equipment arranged in a stacked configuration.

The racks 104 may be arranged to define longitudinal aisles and lateral perimeter aisles, which may serve multiple purposes within the example data center environment 100. The longitudinal aisles and the lateral perimeter aisles may provide access paths for service personnel to perform maintenance operations, create channels for cooling airflow distribution, and establish organized pathways for cable management. The spatial organization of the longitudinal aisles and the lateral perimeter aisles may contribute to the overall operational efficiency of the data center environment 100, allowing for systematic access to equipment while maintaining appropriate environmental conditions.

In the configuration depicted in FIG. 1, the example data center environment 100 may utilize fixed cabling infrastructure and wireless network infrastructure to maintain network connectivity between racks and other connection points. In some aspects, wireless transceivers 112 may be implemented using various wireless communication technologies suitable for data center applications. The wireless transceivers 112 may comprise wireless transceivers, directional antenna systems, beam-steerable millimeter wave access points, or other forms of wireless communication hardware capable of establishing reliable connections within the data center context. The wireless transceivers 112 may be mounted to structural components of the example data center environment 100, such as on top of the racks 104, attached to ceiling support structures, or integrated into other existing infrastructure elements. This strategic placement of wireless transceivers 112 enables the formation of wireless communication links between racks, between individual computing devices 108, or between logical network zones within the data center environment 100. The positioning of the wireless transceivers 112 may be determined based on coverage requirements, potential interference patterns, and the specific communication needs of different areas within the environment.

In some aspects, a hybrid approach utilizing wireless and wired communication capability allows for the selective utilization of wireless or wired communication paths based on various factors such as workload characteristics, bandwidth requirements, latency sensitivity, and resource availability. For example, a system may dynamically determine an appropriate communication path for different data flows, potentially shifting certain connections from wired to wireless links or vice versa as conditions change.

FIG. 1 further illustrates a diagram 114 of a portion of the data center environment 116 corresponding to the data center environment 100 and showing a wireless communication topology between multiple server racks. In the diagram 114, several racks 104 are illustrated, each equipped with wireless transceivers 112 that enable wireless communication between the racks. The wireless transceivers 112 may operate at various frequencies, including millimeter wave or terahertz frequencies, to provide high-bandwidth connectivity with low latency characteristics suitable for data center applications.

The diagram 114 also depicts potential interference zones 118A, 118B, 118C that may occur within the data center environment 116. These interference zones 118A, 118B, 118C represent areas where wireless signals may experience degradation due to various factors such as signal reflection, absorption, or interference from other wireless communications. The wireless transceivers 112 may be configured to collect performance metrics, including but not limited to signal-to-noise ratio, throughput, packet loss rate, and interference levels. These metrics may be provided to a machine-learning model that utilizes the metrics to identify suboptimal performance conditions or potential interference issues. Based on this analysis, the machine-learning model may generate updated wireless parameters, such as frequency allocations, modulation schemes, and transmission power levels, which are then distributed to the wireless transceivers 112 for implementation. The updated wireless parameters may then be used to cause the wireless communication network to adapt in real-time to changing load conditions and interference patterns

The data center environment 100 illustrated in FIG. 1 demonstrates how wireless connectivity may be implemented in a manner that enables dynamic adaptation to changing conditions, potentially reducing maintenance requirements and improving overall network performance. Unlike traditional data center configurations that rely primarily on fixed cabling infrastructure to maintain network connectivity, aspects described herein provide enhanced flexibility and resource utilization, allowing for the addition or modification and/or relocation of devices without necessitating physical reconfiguration of cabling, scheduled maintenance windows, or potential service disruptions.

The depiction in FIG. 1 is for illustration purposes only, and other configurations are contemplated, including different rack arrangements, alternative placement of wireless transceivers, varying numbers of interference zones, and diverse implementation strategies for the machine-learning models that drive the self-optimization process.

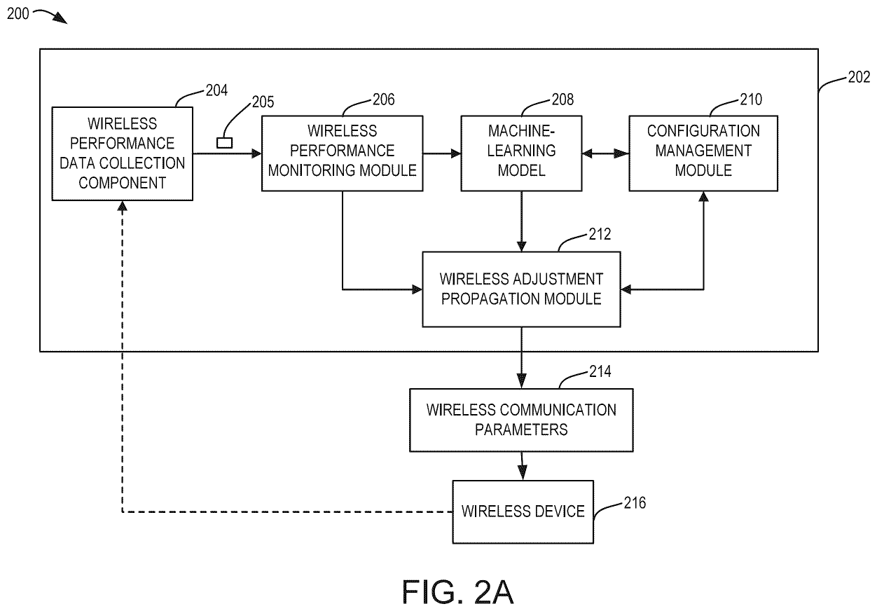

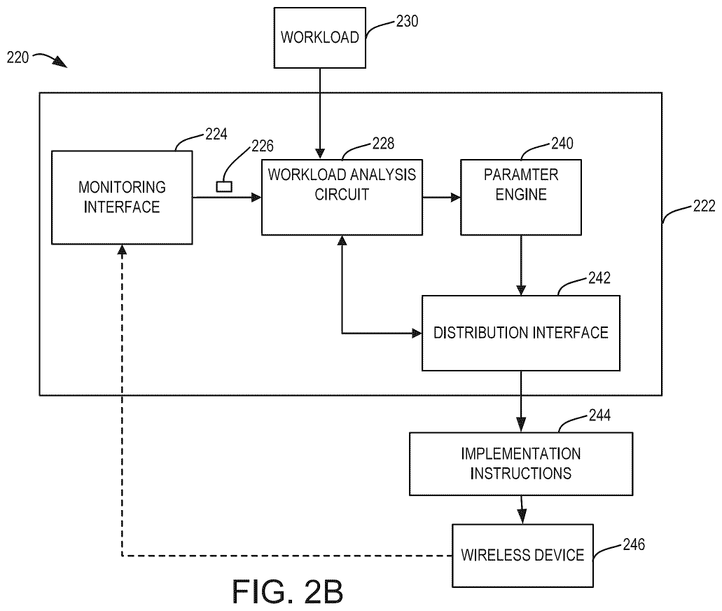

Referring now to FIG. 2, a block diagram of a wireless communication control system 200 is illustrated according to various embodiments of the present disclosure. In some aspects, the wireless communication control system 200 comprises multiple interconnected components configured to dynamically manage wireless parameters for a data center environment based on performance data obtained from wireless devices within the data center. The wireless communication control system 200 may be implemented within a controller 202, which may include one or more computing devices such as servers, switches, or dedicated orchestration nodes positioned within or in communication with the data center environment.

The controller 202 may be implemented as a centralized device operating as a primary management entity for wireless resource optimization across the data center, or alternatively, may be implemented in a distributed manner with functionality spread across multiple physical or virtual devices. In some aspects, the controller 202 may be integrated into existing network management infrastructure, while in other aspects, the controller 202 may be deployed as a standalone system dedicated to wireless communication optimization. The controller 202 may include hardware components such as processors, memory, storage devices, and networking interfaces suitable for executing the operations described herein. In some implementations, the controller 202 may be virtualized, operating as software components within a larger infrastructure management platform.

In some aspects, the wireless communication control system 200 may include a wireless performance data collection component 204 to capture wireless performance data 205, a wireless performance monitoring module 206, a machine-learning model 208, a configuration management module 210, and a wireless adjustment propagation module 212. These components may operate together to create a closed-loop optimization system for wireless communication between data center components, such as servers, racks, storage systems, and networking devices. The wireless performance data collection component 204 may be configured to gather telemetry data from various wireless interfaces or transceivers operating within the data center environment. This performance data may include, but is not limited to, signal strength measurements, throughput metrics, latency values, packet loss statistics, bit error rates, signal-to-noise ratio (SNR) values, interference levels, and channel utilization metrics. In various implementations, the wireless performance data collection component 204 may interface directly with wireless transceivers, with network monitoring systems, or with specialized agents deployed on data center components. The collection of performance data may occur through various protocols, such as but not limited to SNMP (Simple Network Management Protocol), telemetry streaming, API calls, or other data acquisition methods. The wireless performance data collection component 204 may implement data normalization, filtering, and preliminary processing to ensure the incoming performance metrics are suitable for subsequent analysis.

The wireless performance monitoring module 206 may receive the collected performance data from component 204 and perform a detailed analysis to identify trends, anomalies, and/or patterns that may indicate suboptimal wireless performance. The wireless performance monitoring module 206 may implement various analytical methods, such as statistical analysis, threshold-based monitoring, or correlation detection, to derive meaningful insights from the raw performance data. For example, the wireless performance monitoring module 206 may identify wireless links experiencing increasing error rates, channels with growing interference levels, or connections with degrading throughput. The wireless performance monitoring module 206 may also compare current performance against historical baselines and/or predefined service level objectives. The results of this analysis may be provided to the machine-learning model 208 to inform the optimization process.

In some aspects, the machine-learning model 208 represents a computational framework trained to determine optimal wireless communication parameters based on the current and historical performance data. In this context, “optimal” refers to parameter configurations that maximize throughput, minimize latency, reduce packet loss rates, enhance signal-to-noise ratios, and/or mitigate interference, while balancing these factors according to workload priorities and service level objectives established for the data center environment. The machine-learning model 208 may be implemented using various algorithms or techniques, such as neural networks, decision trees, random forests, support vector machines, or reinforcement learning approaches. In some aspects, the machine-learning model 208 may be trained using supervised learning techniques with labeled datasets that map specific wireless performance scenarios to optimal configuration parameters. In other aspects, the machine-learning model 208 may utilize unsupervised or semi-supervised approaches to discover patterns in the data without explicit labeling. The machine-learning model 208 may operate in real-time, processing continuous streams of performance data, or may execute on a scheduled basis to periodically optimize the wireless environment.

The machine-learning model 332 may implement capabilities for spatial analysis of the data center environment to optimize wireless communication through intelligent beamforming. For example, the system may maintain a detailed digital representation of the physical data center layout, including three-dimensional coordinates of all wireless-enabled components, rack positions, structural elements, and potential signal reflectors or absorbers. This spatial model may be augmented with electromagnetic propagation characteristics derived from theoretical models and empirical measurements. Using this comprehensive spatial dataset, the machine-learning model may analyze potential signal paths, reflection points, and interference zones where transmissions from multiple sources may overlap. The system then generates an interference metric for each transceiver by identifying potentially conflicting signal sources, calculating the spectral overlap across frequency bands, and quantifying expected signal degradation based on spatial proximity and transmission power. As described herein, an interference metric may refer to a quantitative measurement that characterizes the potential signal degradation experienced by a wireless transceiver due to competing transmissions from other sources within the data center environment. The interference metric may be calculated as a composite value incorporating multiple factors, including: spectral overlap percentage between transmissions that quantifies the degree to which signals occupy the same frequency ranges; power ratio measurements that compare the strength of desired signals against interfering transmissions; spatial proximity factors that account for the three-dimensional positioning of transceivers relative to potential interference sources; temporal collision probability that estimates the likelihood of simultaneous transmissions based on traffic patterns; and/or signal correlation coefficients that measure the degree of similarity between desired and interfering waveforms. The interference metric may be expressed as a unitless value on a defined scale (e.g., 0-100) or as a decibel ratio, with higher values indicating greater potential for communication disruption. In some aspects, a system generates the interference metric by analyzing the frequency assignments, transmission schedules, and spatial arrangements of active transceivers within the data center environment.

For each wireless link, the model determines optimal beam steering angles that maximize signal strength at the intended receiver while minimizing signal propagation toward identified interference zones. The beam steering calculations may consider direct line-of-sight paths and/or potential multi-path signal propagation that could create constructive or destructive interference. In some aspects, a beam steering angle may refer to a directional coordinate that specifies the primary axis along which an antenna array focuses its transmitted energy or maximizes its reception sensitivity. The beam steering angle may be expressed as a composite of azimuth and elevation components, where the azimuth angle represents the horizontal direction measured in degrees from a reference orientation (typically 0° pointing north or along a predefined axis within the data center), and the elevation angle represents the vertical inclination measured in degrees from the horizontal plane. The beam steering angle may additionally incorporate beamwidth parameters that define the angular spread of the main transmission lobe, expressed in degrees. For adaptive or tracking scenarios, the beam steering angle may include rate-of-change values that specify how quickly the beam direction can be modified in response to changing conditions. The beam steering angle may be determined through computational analysis of the spatial relationships between communicating nodes, taking into account the physical layout of the data center, potential signal reflection points, and the presence of interference zones that should be avoided.

The resulting beamforming parameters may then be encoded in the configuration table with specific directives for antenna array phasing, element weighting, and radiation pattern shaping. In accordance with aspects of the present disclosure, the machine-learning model may be configured to determine interference patterns in the data center and generate corresponding beamforming parameters. As used herein, the beamforming parameters may refer to a set of configuration values that control the directional transmission and reception properties of antenna arrays within wireless transceivers. Beamforming parameters may include, but are not limited to: phase shift values for individual antenna elements that create constructive and destructive interference patterns to shape the radiation pattern; amplitude weights assigned to each antenna element that modify the relative contribution of each element to the composite signal; spatial orientation coordinates that define the three-dimensional targeting of signal energy; polarization settings that specify the electromagnetic wave orientation to maximize signal isolation; and/or nulling coefficients that create deliberate signal cancellation in directions of known interfering devices. The beamforming parameters may enable a wireless communication system to focus signal energy toward intended receivers to improve spectral efficiency in dense data center environments while minimizing signal propagation toward potential interference zones.

When environmental conditions or component positions change, the spatial model may be updated and the machine-learning model may recalculate interference patterns and beamforming parameters accordingly. This spatial-aware optimization approach enables the wireless communication system to achieve significantly higher spectral efficiency through targeted signal focusing and interference isolation, particularly in dense data center environments where traditional omnidirectional wireless approaches would suffer from prohibitive co-channel interference.

The machine-learning model 208 may output wireless parameter recommendations designed to address identified performance issues or to preemptively optimize the wireless environment based on predicted future conditions. In some aspects, these recommendations may include adjustments to modulation schemes, frequency allocations, bandwidth settings, transmit power levels, beam steering parameters, or other wireless configuration elements. The machine-learning model 208 may also prioritize specific adjustments based on their expected impact on overall system performance or based on workload priorities within the data center.

For example, the wireless communication control system may implement dynamic bandwidth allocation mechanisms that adjust spectral resources based on workload priority classifications. When the system identifies varying priority levels among concurrent workloads, the system can perform a bandwidth rebalancing process that reallocates channel resources to optimize overall service delivery. For higher-priority workloads, the system incrementally increases bandwidth allocations by expanding channel width, aggregating multiple frequency bands, or implementing higher-order spatial multiplexing techniques. This expansion process continues until either the performance requirements of the high-priority workload are satisfied or system constraints are reached. In some aspects, the system identifies lower-priority workloads that can tolerate reduced bandwidth and systematically decreases their allocations through channel width reduction, selective carrier deactivation, or spatial stream limitation. The reallocation process may maintain a minimum performance threshold for lower-priority workloads while ensuring maximum resource availability for important or critical operations. The bandwidth adjustment operations may be orchestrated through coordinated parameter updates across affected transceivers. The system may track the effectiveness of the bandwidth adjustments through performance monitoring.

The configuration management module 210 stores configuration data, historical parameter sets, policy constraints, and other information relevant to the management of wireless resources within the data center. The configuration management module 210 may maintain baseline configurations for different types of wireless devices, historical records of parameter adjustments and their effects, and rules or policies that govern the allowable range of parameters. This repository may serve as both a reference for the machine-learning model 208 when generating recommendations and as a constraint mechanism to ensure that recommended changes comply with administrative policies, regulatory requirements, or operational guidelines. The configuration management module 210 may be implemented using various storage technologies, such as databases, file systems, or distributed data stores, and may support versioning, access control, and audit capabilities.

In some aspects, the wireless adjustment propagation module 212 receives parameter recommendations from the machine-learning model 208 and translates the parameter recommendations into specific configuration instructions that can be applied to wireless devices within the data center. The wireless adjustment propagation module 212 may verify recommendations against constraints stored in the configuration management module 210, resolve conflicts between competing recommendations, and determine the appropriate sequencing or timing for parameter changes to minimize disruption to active communications. The wireless adjustment propagation module 212 may generate a set of wireless communication parameters 214 that encapsulate the specific changes to be applied to target wireless devices.

The wireless communication parameters 214 represent the output of the optimization process and include specific configuration settings ready for implementation on wireless devices. These parameters may be formatted according to device-specific requirements, protocol standards, or management interfaces used by the target devices. The wireless communication parameters 214 may be organized into configuration profiles, command sequences, or policy updates depending on the implementation approach. The wireless device 216 represents one or more physical or virtual entities that implement wireless communication capabilities within the data center environment. Wireless devices 216 may include wireless network interfaces on servers, wireless-enabled switches or routers, dedicated wireless access points, or specialized wireless adapters. Upon receiving the wireless communication parameters 214, the wireless device 216 applies the configuration changes to its operational settings, thereby completing the optimization cycle. The wireless device 216 continues to generate performance telemetry as it operates, which is then collected by the wireless performance data collection component 204, thus creating a continuous feedback loop for ongoing optimization. The dashed line from the wireless device 216 back to the wireless performance data collection component 204 indicates this feedback path, where the effects of parameter adjustments can be measured and evaluated to inform subsequent optimization cycles. This closed-loop approach enables the system to adapt continually to changing conditions within the data center environment, such as varying workloads, physical changes to the facility, or emerging interference sources.

In operation, the system 200 continuously monitors wireless performance, analyzes the collected data, determines optimal parameter settings through machine-learning, and propagates those settings to wireless devices throughout the data center. This dynamic optimization process occurs without requiring manual intervention, enabling a wireless infrastructure to maintain optimal performance despite changing conditions. The system 200 may implement various optimization strategies, such as prioritizing critical workloads, balancing resources across wireless links, or mitigating interference through coordinated parameter adjustments.

Referring now to FIG. 2B, a block diagram of a wireless communication management device 222 is illustrated in accordance with aspects of the present disclosure. The wireless communication management device 222 comprises multiple interconnected components configured to analyze wireless performance metrics, evaluate workload characteristics, and generate optimized wireless parameters for a data center environment. In some aspects, the wireless communication management device 222 includes a monitoring interface 224, a workload analysis circuit 228, a parameter engine 240, and a distribution interface 242. The wireless communication management device 222 may be communicatively coupled to a workload source 230, which provides workload information to the workload analysis circuit 228. The workload source 230 may represent an operational management system, scheduler, or other component that maintains information about active and pending computational tasks within the data center environment.

The monitoring interface 224 may be configured to receive wireless performance metrics 226 from a plurality of wireless links between data center components. The monitoring interface 224 may capture various telemetry data including, but not limited to, signal strength measurements, throughput metrics, latency values, packet loss statistics, bit error rates, signal-to-noise ratio (SNR) values, interference levels, and channel utilization metrics. The monitoring interface 224 may implement data normalization, filtering, and preliminary processing to prepare the performance metrics for subsequent analysis. The workload analysis circuit 228 receives workload information from the workload source 230 and performance data from the monitoring interface 224. The workload analysis circuit 228 may be configured to identify different categories of data traffic based on workload characteristics, determine priority levels for the different categories of data traffic, and map the priority levels to wireless resource requirements. For example, the workload analysis circuit 228 may classify data flows as control and management traffic, data backup traffic, or real-time application traffic, each with corresponding priority levels and resource needs.

In some aspects, the parameter engine 240 receives input from the workload analysis circuit 228 and may also receive direct input from the monitoring interface 224. The parameter engine 240 may analyze the received wireless performance metrics and the wireless resource requirements determined by the workload analysis circuit 228. Based on this analysis, the parameter engine 240 may determine wireless communication parameters for each wireless link of the plurality of wireless links and generate implementation instructions 244 for the wireless communication parameters. The wireless communication parameters may include, but are not limited to, modulation schemes, frequency allocations, bandwidth settings, transmit power levels, and beam steering parameters.

The implementation instructions 244 generated by the parameter engine 240 comprise a structured set of configuration directives specifically formatted for consumption by wireless devices 246 within the data center environment. In some aspects, the implementation instructions 244 may include device-specific command sequences, parameter value pairs, configuration profiles, or policy updates depending on the capabilities and management interfaces of the target wireless devices. The implementation instructions 244 may encapsulate various wireless parameters such as frequency channel assignments (e.g., “operate on channel 140 at 5.7 GHz”), modulation scheme directives (e.g., “transition from 64-QAM to 256-QAM”), power level adjustments (e.g., “reduce transmission power by 3 dB”), bandwidth allocation commands (e.g., “increase channel width from 40 MHz to 80 MHz”), beam steering coordinates (e.g., “adjust antenna array phase to focus transmission at azimuth 275°, elevation 15°”), and timing parameters for coordinated implementation. In some aspects, the implementation instructions 244 may also include validation procedures that the wireless devices 246 should execute after applying the new parameters, enabling closed-loop verification of successful parameter application. The implementation instructions 244 may be prioritized with metadata indicating their urgency, dependencies on other configuration changes, or workload relevance, allowing receiving devices to sequence parameter updates appropriately to minimize service disruption while maximizing performance improvements.

The distribution interface 242 may receive the implementation instructions 244 from the parameter engine 240 and transmit the implementation instructions to one or more wireless devices 246 associated with the plurality of wireless links. The distribution interface 242 may implement various communication protocols and management interfaces to ensure reliable delivery of the implementation instructions 244 to the target wireless devices 246. The wireless devices 246 apply the received parameters to their operational settings, thereby completing the optimization cycle. The wireless devices 246 continue to generate performance metrics that are collected by the monitoring interface 224, as indicated by the dashed feedback path, thus creating a continuous feedback loop for ongoing optimization. In operation, the wireless communication management device 222 monitors wireless performance, analyzes workload characteristics, determines optimal parameter settings, and propagates those settings to wireless devices throughout the data center, enabling a wireless infrastructure to maintain optimal performance despite changing conditions.

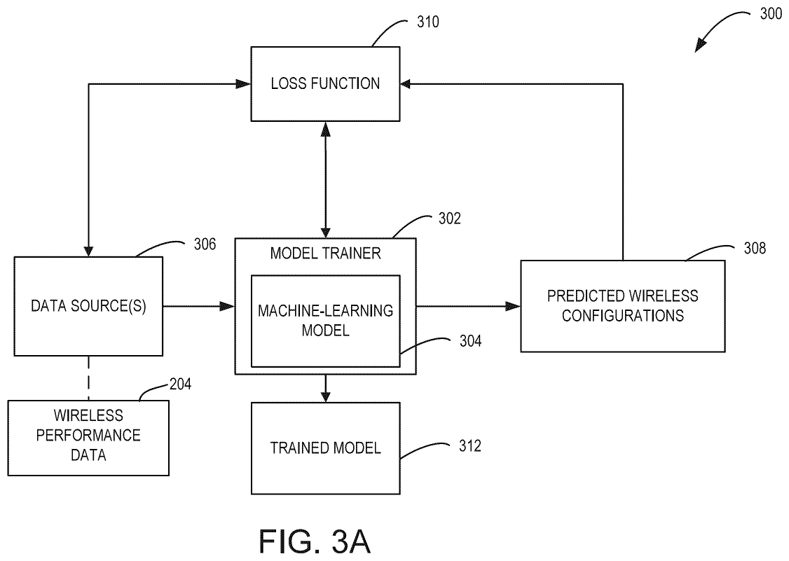

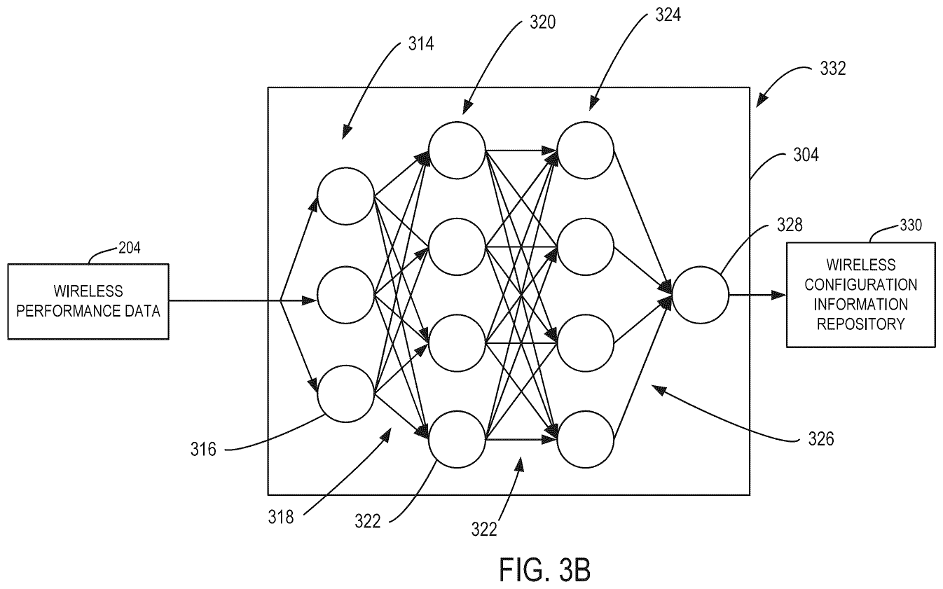

Referring now to FIG. 3A, a schematic of an ML training framework 300 is depicted in accordance with aspects of the present disclosure. In some aspects, the ML training framework 300 represents a system for developing, training, and deploying machine-learning models configured to predict and generate optimized wireless communication parameters for data center environments. The framework 300 may include multiple interconnected components that work together to process historical and real-time network data to produce a trained model capable of making intelligent parameter adjustments without manual intervention. At the center of the framework 300 is a model trainer 302, which houses and manages the training process for a machine-learning model 332. The model trainer 302 comprises computational hardware and software components designed to implement and execute various machine-learning algorithms. In some aspects, the model trainer 302 may include one or more processors, memory modules, storage devices, and specialized hardware accelerators such as Graphics Processing Units (GPUs) or Tensor Processing Units (TPUs) for machine-learning workloads. The model trainer 302 may be implemented as a dedicated training server, a distributed computing cluster, or as virtualized instances within a cloud computing environment. In some aspects, the model trainer 302 orchestrates the training workflow, including data ingestion, preprocessing, model initialization, training iterations, evaluation, and model persistence.

The ML model 304 represents a component that learns patterns and relationships between wireless network conditions and optimal parameter configurations. The machine-learning model 332 may be implemented using various techniques, including, but not limited to, neural networks, decision trees, random forests, gradient-boosted trees, support vector machines, or ensemble methods combining multiple algorithms. In some aspects, the machine-learning model 332 may employ deep learning architectures such as convolutional neural networks (CNNs) for processing spatial data related to wireless signal propagation, recurrent neural networks (RNNs) or long short-term memory (LSTM) networks for capturing temporal patterns in network performance, or transformer-based architectures for modeling complex dependencies across different network parameters. The structure and complexity of the machine-learning model 332 may be tailored to the specific characteristics of the wireless communication environment within the data center, the volume and dimensionality of available training data, and the desired precision of parameter predictions.

In some aspects, the framework 300 receives input from one or more data sources 306, which provide the historical and contextual information for model training. The data sources 306 may comprise structured and unstructured repositories of information relevant to wireless network performance and configuration. The data sources 306 may include, but are not limited to, historical wireless link performance logs that capture time-series data on signal quality, throughput, and/or error rates across various network conditions; application-level metrics that provide insight into the performance requirements and behaviors of workloads running within the data center; environmental telemetry data that characterizes physical conditions within the data center such as temperature variations, airflow patterns, and electromagnetic interference signatures; and records of prior configuration outcomes documenting the effects of previous parameter adjustments on network performance. In some aspects, data source 306 may also include simulation data generated from computational models of wireless propagation within data center environments, providing synthetic examples of network behavior under conditions that may be difficult to observe in production environments.

As indicated by the dashed line connection in FIG. 3A, the data sources 306 may be supplemented by wireless performance data 205 collected by the wireless performance data collection component 204 and/or the wireless performance monitoring module 206 described with respect to FIG. 2. This connection represents the integration between runtime monitoring systems and the training framework, enabling the continuous enhancement of the model using recent operational data. In some aspects, the wireless performance data 205 provides real-world feedback on the effectiveness of previously deployed parameter configurations, creating a closed-loop learning system that improves over time through direct observation of actual network behavior.

During the training process, the model trainer 302 processes the input data to generate one or more predicted wireless configurations 308. The predicted wireless configurations 308 represent the output of the machine-learning model 332 in response to specific input conditions and comprise a comprehensive set of parameter recommendations for optimizing wireless communication links. The predicted wireless configurations 308 may include, but are not limited to, recommended modulation schemes that determine how information is encoded onto carrier signals; bandwidth allocations that specify the portion of the frequency spectrum assigned to different communication channels; antenna beam angles that control the directionality of wireless transmissions for improved signal focus and reduced interference; transmission power levels that balance signal strength against energy consumption and interference potential; and/or frequency channel assignments that distribute communication across available spectrum to minimize contention and maximize overall throughput.

In some aspects, the framework 300 may utilize a loss function 310 to evaluate and refine the training process. The loss function 310 may operate as a quantitative measure of the deviation between the predicted configurations generated by the machine-learning model 332 and the actual optimal configurations as determined by network outcomes. The loss function 310 may implement various mathematical formulations to calculate this deviation, including mean squared error, cross-entropy, or custom metrics designed to emphasize particular aspects of wireless performance, such as, but not limited to, latency, stability, or throughput. In some aspects, the loss function 310 may implement a multi-objective formulation that balances multiple competing objectives, such as maximizing throughput while minimizing energy consumption or balancing latency against reliability. The bidirectional arrows connecting the loss function 310 to other components in FIG. 3A indicates the iterative nature of the training process, where the calculated loss informs adjustments to the model parameters to progressively reduce prediction errors. Additionally, as illustrated by the connection between data source 306 and loss function 310, ground truth data provided from data source 306 may be supplied directly to loss function 310 for comparing against the predicted configurations. The ground truth data may be used to provide an objective evaluation of the performance of the machine-learning model 332 when compared to actual historical outcomes and optimal configurations from previous deployments.

Upon completion of the training process (e.g., when the loss function reaches a threshold value or convergence criteria indicating suitable prediction accuracy), the machine-learning model 332 may be finalized and committed as a trained model 312. The trained model 312 represents the culmination of the learning process and encapsulates the knowledge extracted from the training data in a form that can be deployed for operational use. The trained model 312 may be serialized and stored in various formats suitable for deployment, such as TensorFlow SavedModel, ONNX (Open Neural Network Exchange), or custom binary representations optimized for the target deployment environment. In some aspects, the trained model 312 may undergo additional post-processing steps, such as quantization to reduce computational requirements, pruning to eliminate redundant parameters, or knowledge distillation to create smaller, more efficient versions while preserving prediction accuracy.

Once deployed, the trained model 312 may be integrated within the system (e.g., as machine-learning model 208 in FIG. 2) for live inference, where it may process real-time inputs from the operational environment to generate wireless communication parameters during runtime. This deployment enables autonomous adaptation and continuous performance optimization of the wireless communication infrastructure within the data center, responding to changing workload conditions, interference patterns, and connectivity requirements without manual intervention.

The ML training framework 300 may implement various training methodologies depending on the specific requirements and constraints of the wireless communication optimization task. In some aspects, the ML training framework 300 may use supervised learning approaches, where the machine-learning model 332 is trained on labeled examples that may include input network conditions paired with known optimal parameter configurations. In other aspects, the framework may utilize reinforcement learning techniques, where the machine-learning model 332 may learn through trial and error by observing the outcomes of different parameter adjustments in terms of network performance improvements. The ML training framework 300 may also incorporate transfer learning approaches, where knowledge gained from training in one data center environment can be partially applied to accelerate learning in new or modified environments with different physical layouts or hardware configurations.

Referring now to FIG. 3B, an illustration of a machine-learning model 332 is depicted in accordance with aspects of the present disclosure. In some aspects, the machine-learning model 332 represents a system configured to generate wireless configuration parameters based on received performance data. In some implementations, the machine-learning model 332 may correspond to the trained model 312 described with reference to FIG. 3A and/or the machine-learning model 208 of FIG. 2, now deployed for runtime operation within a data center environment. The machine-learning model 332 may receive wireless performance data 205 as input. As previously described, the wireless performance data 205 may comprise various metrics collected from wireless devices operating within a data center environment, such as signal-to-noise ratios, throughput measurements, latency values, packet loss rates, interference levels, channel utilization statistics, and/or other performance indicators relevant to wireless communication quality. The wireless performance data 205 may be provided to the machine-learning model 332 in real-time, near-real-time, or as aggregated data collected over predetermined intervals.

In some aspects, the machine-learning model 332 comprises a neural network 304, which provides a computational structure for processing the wireless performance data 205 and generating appropriate configuration recommendations. The neural network 304 may include an input layer 314 comprising a plurality of input nodes 316. Each input node 316 may correspond to a specific feature or metric from the wireless performance data 205. For example, individual input nodes 316 may receive values representing different aspects of wireless performance, such as received signal strength for a particular link, current modulation efficiency, interference measurements for specific frequency bands, and/or traffic load on a given wireless channel. The number of input nodes 316 may vary depending on the dimensionality of the input data and the specific design of the machine-learning model. In some implementations, the input layer 314 may also include preprocessing components that normalize, scale, or otherwise transform the raw input data for more effective learning and inference.

The neural network 304 may include one or more hidden layers 320. Each hidden layer 320 may comprise multiple hidden nodes 322 interconnected through weighted connections. The hidden nodes 322 may perform intermediate computations that transform the input data through a series of mathematical operations, typically including weighted sums followed by non-linear activation functions. In some aspects, the activation functions introduce non-linearity into the model, enabling it to capture complex relationships between input features and target outputs. The weights associated with connections between nodes represent the knowledge learned during the training process described with reference to FIG. 3A, encoding patterns and relationships identified in historical wireless performance data.

The architecture of the hidden layers 320 may vary depending on the complexity of the wireless optimization task and the characteristics of the data center environment. In some implementations, the hidden layers 320 may employ different types of neural network structures, such as fully connected layers, convolutional layers for processing spatial relationships in wireless signal propagation, or recurrent layers for capturing temporal patterns in performance metrics. The neural network 304 may also include additional architectural elements not explicitly depicted, such as dropout layers to prevent overfitting, batch normalization components to stabilize learning, or residual connections to facilitate gradient flow during training.

The connections between nodes, represented by directed edges 318 and 322 in FIG. 3B indicates the flow of information through the neural network. Each connection may carry a weighted value from one node to another, with the weight determining the influence of the “SOURCE NODE” s output on the destination node's input. The collection of all weights in the network constitutes the model's learned parameters, which are established during the training process and remain fixed during inference operations in the deployed model.

The final stage of the machine-learning model 332 comprises an output layer 324, which produces the predicted wireless configuration parameters 328. The output layer 324 includes output nodes that generate specific values corresponding to different wireless configuration settings. These settings may include, but are not limited to, recommended modulation schemes, frequency channel assignments, bandwidth allocations, transmission power levels, beamforming parameters, and other adjustable aspects of wireless communication that can be tuned to optimize performance. The directed edges from the final hidden layer nodes to the output layer 324 and subsequently to the wireless configuration parameters 326 represent the culmination of the data processing path through the neural network, where the processed information is transformed into specific configuration recommendations.

The predicted wireless configuration parameters 328 may be passed to a wireless configuration information repository 330, which may correspond to the configuration management module 210 described with reference to FIG. 2. The wireless configuration information repository 330 may store the recommended parameter settings and may serve as an interface between the machine-learning model 332 and the operational components of the wireless communication system. In some implementations, the wireless configuration information repository 330 may implement version control, configuration validation, conflict resolution, or policy enforcement before the recommended parameters are propagated to wireless devices within the data center.

The machine-learning model 332 enables a data-driven approach to wireless parameter optimization, where configuration decisions may be based on empirical observations of system performance rather than static rules or manual adjustments. In some aspects, this approach allows the wireless communication infrastructure to adapt autonomously to changing conditions within the data center environment, such as varying workload demands, physical reconfigurations, or emerging interference sources.

The neural network 304 depicted in FIG. 3B is presented for illustrative purposes, and various modifications or alternative implementations may be employed while remaining within the scope of the present disclosure. For instance, the machine-learning model 332 may be implemented using alternative machine-learning techniques such as decision trees, random forests, support vector machines, or ensemble methods combining multiple model types. The specific number of layers, nodes, and connections may be adjusted based on the complexity of the optimization task, the volume and characteristics of available training data, and the computational resources available for model inference. In operation, the machine-learning model 332 continuously processes incoming wireless performance data 205, generating updated configuration recommendations in response to evolving conditions within the data center. This continuous adaptation enables the wireless communication system to maintain optimal performance without requiring manual intervention, potentially reducing maintenance overhead and improving overall network efficiency.

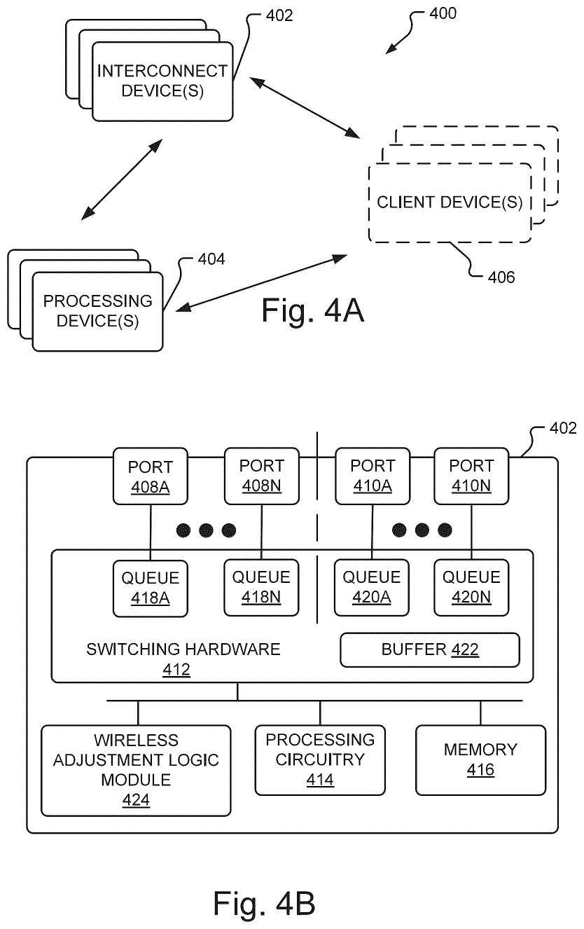

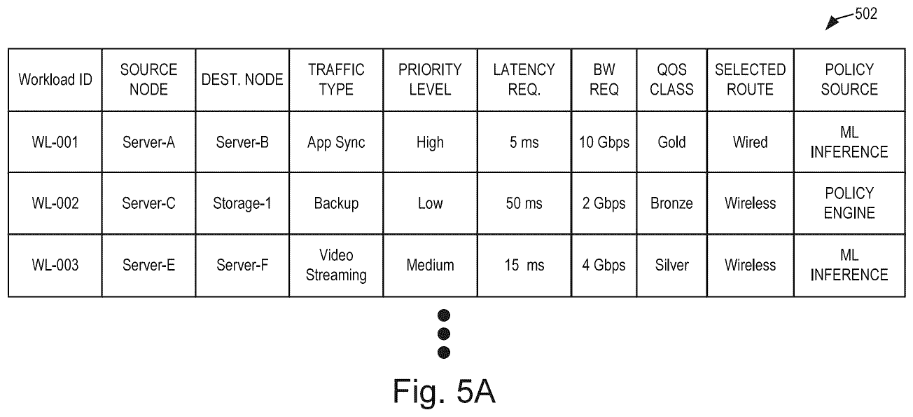

As illustrated in FIG. 4A, a computing environment 400 as described herein may include a network of processing devices 404 which may be interconnected by a fabric. A fabric, as described herein, may include one or more interconnect devices 402 and/or one or more processing devices 404. The one or more interconnect devices 402 may be in communication with the processing devices 404 as well as one or more other computing systems such as client devices 406. Such a network of processing devices 404 and interconnect devices 402 may be useful in various settings, from data centers and cloud computing infrastructures to AI systems.

Processing devices 404 may be computing units, such as personal computers, servers, or other computing devices, and may be responsible for executing applications and performing data processing tasks. Processing devices 404, as described herein, can range from servers in a data center to desktop computers in a network, or to devices such as internet of things (IoT) sensors and smart devices.

One or more of the processing devices 404 may include one or more processing circuits, such as GPUs, central processing units (CPUs), application-specific integrated circuits (ASICs), field programmable gate arrays (FPGAs), or other circuitry capable of performing computations, as well as memory and storage resources to run software applications, handle data processing, and perform specific tasks as needed. In some implementations, processing devices 404 may also, or alternatively, include hardware, such as GPUs for handling computationally intensive tasks for machine-learning, artificial intelligence (AI) workloads, or other complex processes.

For example, processing devices 404 may operate as a high-performance computing (HPC) cluster. A cluster of processing devices 404 may comprise numerous interconnected servers, each equipped with powerful CPUs and/or GPUs. The processing devices 404 may provide computational horsepower for, as an example, training large-scale AI models or running complex scientific simulations. For AI and machine-learning tasks, the processing devices 404 may comprise one or more GPUs or other processing circuitry which may be capable of handling parallel processing requirements of neural networks and other applications.

Interconnect devices 402, as described in greater detail herein, may enable communication between processing devices 404 and/or client devices 406. An interconnect device 402 may be, for example, a network switch, a network interface controller (NIC), or other device capable of receiving and sending data, and may act as a central node in the network. Interconnect devices 402 may be wired in a topology including spine switches and top-of-rack (TOR) switches for example. Interconnect devices 402 may be capable of receiving, processing, and forwarding data, e.g., packets, to appropriate destinations within a network. In some aspects, such destinations may include but are not limited to processing devices 404 and/or client devices 406. In some implementations, an interconnect device 402, as described herein, may be included in a switch box, a platform, or a case that may contain one or more interconnect devices 402 and one or more power supply devices.

In some implementations, one or more processing devices 404 may be connected to one or more ports of one or more interconnect devices 402 via network cables. In some aspects, one or more processing devices 404 may be wirelessly connected to one or more ports of one or more interconnect devices 402. Processes, such as applications, executed by processing devices 404 may involve transmitting data to nodes of the network, such as to other processing devices 404 and/or to client devices 406. Data may flow through the network of processing devices 404 and interconnect devices 402 using one or more protocols such as transmission control protocol (TCP), user datagram protocol (UDP), or Internet protocol (IP), for example. One or more interconnect devices 402 may, upon receiving data from a processing device 404 or another interconnect device 402, examine the data to identify a destination for the data and route the data through the network.

Client devices 406, as described herein, may refer to computing devices that perform AI-related, research-related, and/or other processor-intensive tasks. To manage substantial computational loads and data throughput that may be needed for such applications, client devices 406 may utilize one or more processing devices 404. Examples of client devices 406 include but are not limited to workstations and personal computers used by researchers, data scientists, and/or professionals for developing, testing, and/or executing AI models and research simulations. While a client device 406 may be equipped with one or more CPUs and/or GPUs, one or more client devices 406 may need additional computational resources to perform complex tasks in an efficient manner. By interacting with processing devices 404, client devices 406 may be enabled to perform functions such as, for example, training machine-learning models, performing data processing, running simulations, analyzing large datasets, and/or performing complex data processing tasks, such as data mining, pattern recognition, and/or predictive modeling.

In some implementations, the fabric may include wireless communication devices that establish wireless links between processing devices 404 and/or interconnect devices 402. The wireless communication devices may utilize millimeter wave or terahertz frequencies to provide high-bandwidth, low-latency wireless connectivity suitable for data center applications. The wireless communication devices may be configured to self-optimize by automatically adjusting parameters such as signal strength, frequency, bandwidth allocation, and modulation schemes in response to changing network conditions and workload requirements. One or more interconnect devices 402 may incorporate hybrid connectivity capabilities, supporting both wired and wireless communication interfaces. Such hybrid devices enable dynamic allocation of communication resources based on workload prioritization, bandwidth requirements, and current network conditions. In some implementations, these hybrid interconnect devices may utilize machine-learning models to determine optimal wireless parameters and route traffic accordingly, adjusting communication pathways to maintain optimal performance while minimizing maintenance requirements.

FIG. 4B depicts additional details of an interconnect device 402 in accordance with examples of the present disclosure. In some aspects, an interconnect device 402 may include a plurality of ports 408a-408n/410a-410n, switching hardware 412, processing circuitry 414, memory 416, and wireless adjustment logic module 424. The interconnect device 402 may include one or more ports 408a-408n/410a-410n configured to send and receive data in the form of packets, frames, and/or other units of information. The ports 408a-408n/410a-410n may be referred to as hardware ports, representing physical interfaces capable of handling communication through copper, fiber, or radio frequency links. Ports 408a-408n (wired) support transmission over physical cabling, while ports 410a-410n (wireless) support wireless communication protocols suitable for high-throughput data center environments. A “hardware port” may refer to a physical interface on a network switching device (also referred to as a switch and a network switch herein), such as an Ethernet or fiber-optic port, through which network packets are transmitted and received over physical media. A hardware port may be distinct from a “logical port,” which may refer to a software-defined endpoint identified by a numerical designation used to facilitate protocol-specific communication between networked devices at the transport or application layer. Although embodiments are discussed primarily involving hardware ports, embodiments of the present disclosure may also be applied to logical ports.

In some aspects, each port 408a-408n may support high-speed data transfers over physical cabling, such as copper or fiber-optic cables. In certain aspects, one or more ports 410a-410n may be compatible with one or more wireless transceivers. In some aspects, the ports 410a-410n may refer to a physical radio interface, logical port or SSID tied to a virtual access point, and/or a beamformed direction link to a specific destination node. The ports 408a-408n/410a-410n may be configured to accommodate one or more communication standards and protocols, including Ethernet, InfiniBand, and/or proprietary link-layer protocols, thereby enabling flexible deployment in diverse networking environments. Each port 408a-408n/410a-410n may dynamically switch between ingress and egress functionality or operate in dedicated ingress or egress modes, depending on an overall configuration and management policies configured via, for example, software or firmware.

In some aspects, each port 408a-408n/410a-410n may incorporate physical layer devices (PHYs) and/or logic that perform signal encoding/decoding, clock and data recovery, and other low-level operations. These components may be implemented in ASICs, FPGAs, or discrete modules. Ports may also include local buffers or queues, queues 418a-418n for wired ports and queues 420a-420n for wireless ports, to temporarily store data before switching. In certain implementations, the port-specific buffers or queue 418a-418n/420a-420n may be referred to as on-chip or external memory elements. The on-chip or external memory elements may work with larger shared resources, such as buffer 422, to provide efficient queuing and management of traffic. The configuration and operational status of each port 408a-408n/410a-410n, such as speed, duplex settings, or active/inactive state, may be monitored by the processing circuitry 414. Furthermore, ports 408a-408n/410a-410n may provide status indicators or counters (e.g., for packets transmitted or dropped) that can be accessed by higher-level software for analytics or troubleshooting. The ports 408a-408n/410a-410n may provide one or more interface points that connect the interconnect device 402 to external devices, thereby enabling one or more traffic management, congestion management, and/or load balancing techniques described herein. In some aspects, one or more queues 418a-418n/420a-420n may be utilized for per-client buffering, traffic prioritization, MAC-layer retransmissions, and/or QoS and airtime fairness enforcement.

In some aspects, the one or more of the queues 418a-418n/420a-420n may be configured to temporarily hold data units (e.g., packets) awaiting transmission or processing. In some implementations, the one or more queues 418a-418n/420a-420n may be implemented in hardware as dedicated first-in-first-out (FIFO) buffers, circular buffers, or other structures capable of being dynamically partitioned. For example, in an implementation where the interconnect device 402 supports multiple “PRIORITY LEVEL” , high-priority traffic (such as real-time video or voice data) may be assigned to a dedicated queue with expedited processing, while lower-priority data (such as background file transfers) may be placed in another queue with a best-effort service policy.

The number of queues 418a-418n/420a-420n can vary according to one or more configurations. For example, an implementation may assign a separate queue to each port 408a-408n/410a-410n. In other implementations, one or more queues 418a-418n/420a-420n may be allocated based on traffic classes, “PRIORITY LEVEL” , or virtual channels. In some aspects, one or more queues 418a-418n/420a-420n collectively perform flow-control tasks by absorbing bursts of incoming data and releasing them at a rate consistent with downstream capacity. For instance, in a data center environment running HPC applications, each queue 418a-418n/420a-420n may correspond to a particular “TRAFFIC TYPE”, such as compute, storage, or management, and selectively throttle certain types of traffic whenever multiple ports ramp up simultaneously. By grouping traffic this way, a system can process a burst of new data transmissions without saturating downstream resources.

In some aspects, the switching hardware 412 may include one or more integrated circuits, multiplexers, crossbar fabrics, or other data-forwarding components arranged to direct incoming data from a port (e.g., one or more ports 408a-408n/410a-410n) to one or more destination ports based on switching logic for Layer 2 forwarding and/or routing logic for Layer 3 processing. In some implementations, the switching hardware 412 may operate at line-rate speeds (i.e., processing packets at the maximum theoretical speed of the network interface), ensuring minimal latency while maintaining reliable throughput. The switching hardware 412 may incorporate dedicated forwarding tables or pipelines that analyze header information, such as media access control (MAC) addresses for Layer 2 switching, virtual local area network (VLAN) tags, or network-layer identifiers such as Internet Protocol (IP) addresses for Layer 3 routing, to determine how best to forward each data unit within the interconnect device 402. In addition, the switching hardware 412 may utilize programmable match-action stages (i.e., processing pipeline stages that compare incoming packet fields against predefined patterns and execute corresponding actions), enabling adaptation to evolving network needs through software-defined updates. For instance, a reconfiguration of the switching hardware 412 may implement different flow-control strategies, advanced monitoring capabilities, or security filters without needing a redesign of the switching hardware 412.

In some aspects, the switching hardware 412 may also coordinate with the wireless adjustment logic module 424 which implements the self-optimizing wireless communication framework. The wireless adjustment logic module 424 implements the self-optimizing wireless communication framework described with reference to FIG. 2 and FIG. 3. The wireless adjustment logic module 424 may collect wireless performance parameters associated with communications between data center components, including signal-to-noise ratios, throughput metrics, latency values, and interference levels as shown in the wireless performance data collection component 204 of FIG. 2. The performance parameters are input into a machine-learning model similar to model 208 (FIG. 2) and model 304 (FIG. 3), which has been trained on data center-specific wireless characteristics to determine optimal parameter adjustments. The machine-learning model, which may comprise neural network architectures as illustrated in FIG. 3B, processes this data and outputs wireless communication adjustment parameters, including modulation scheme adjustments, frequency allocations, bandwidth settings, and transmission power levels. These parameters are then stored in memory 416 as part of a configuration table that maps data center components to their corresponding wireless settings. Based on workload information collected from processing devices 404 (FIG. 4A), the wireless adjustment logic module 424 may also identify and prioritize data traffic, adjusting bandwidth allocations accordingly. The module continuously monitors performance metrics and propagates updated wireless parameters to all affected wireless ports 410a-410n, creating a closed-loop optimization system that maintains optimal wireless performance without manual intervention. The processing circuitry 414 manages overall device operations, while memory 416 stores configuration data, operational parameters, and/or wireless adjustment parameters.

The processing circuitry 414 may comprise one or more processors, microcontrollers, digital signal processors (DSPs), or dedicated ASIC blocks configured to manage system-level operations of the interconnect device 402. In some implementations, the processing circuitry 414 may execute firmware stored in memory 416 to maintain routing tables, manage port configuration parameters (e.g., enabling or disabling specific ports 408a-408n/410a-410n), and apply quality-of-service policies. The processing circuitry 414 can interface with higher-level management tools, such as a network orchestration platform or a cloud-based controller, to convey telemetry data or receive updated resource management circuitry/logic on the fly. By offloading some decisions to the switching hardware 412, the processing circuitry 410 can remain available for more complex tasks, including congestion analytics, device configuration, and other diagnostic tasks (e.g., performing debugging of flow-control counters or verifying compliance with service-level agreements). Accordingly, the interconnect device 402 can maintain a high level of throughput while still providing congestion management and adaptive routing functionality.

The interconnect device 402 may include memory 416 that may utilize one or more storage technologies, such as DRAM, SRAM, TCAM, or flash. In some aspects, DRAM may store large routing tables or buffering data, SRAM could serve as high-speed scratchpads for real-time operations, while TCAM could facilitate rapid lookups for routing or security rules. Regardless of the specific technology, memory 416 can be used to make configuration parameters, firmware images, and runtime data structures readily accessible to the processing circuitry 414. In certain aspects, memory 416 may house a lightweight operating system or embedded software stack that manages hardware resources and provides an interface for remote configuration and updates. Moreover, memory 416 may enable virtualization capabilities, allowing multiple logical partitions (or “slices”) of the device to operate independently, which may be useful in large-scale data centers or cloud environments, where different tenants or workloads may need isolated resources and custom flow-control settings.

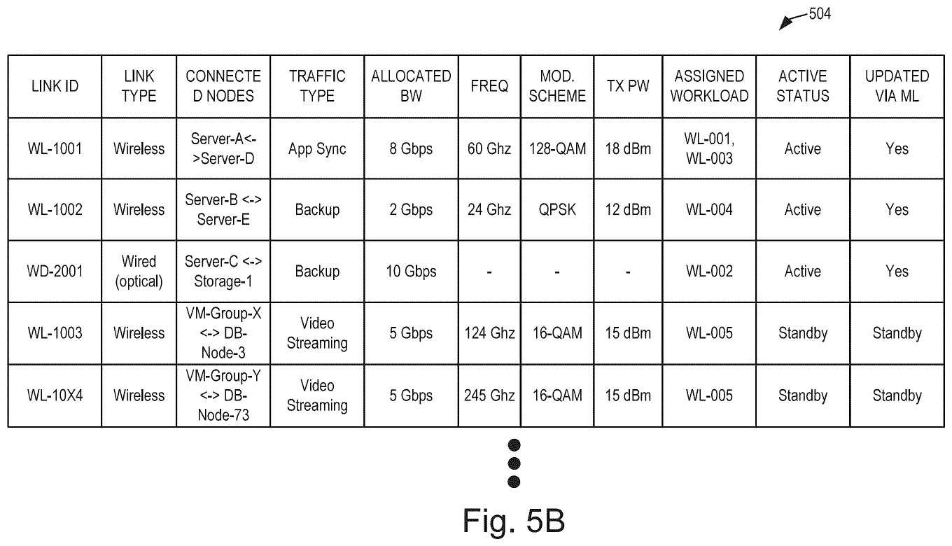

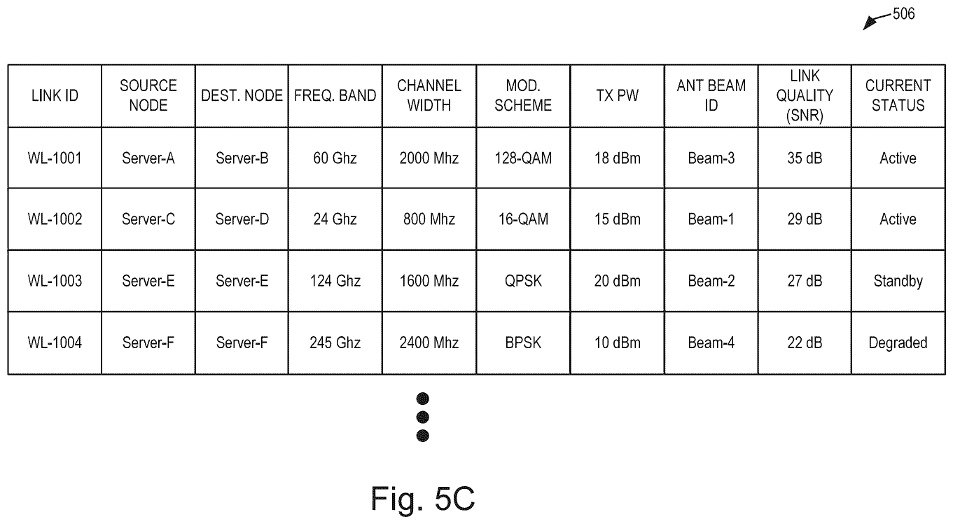

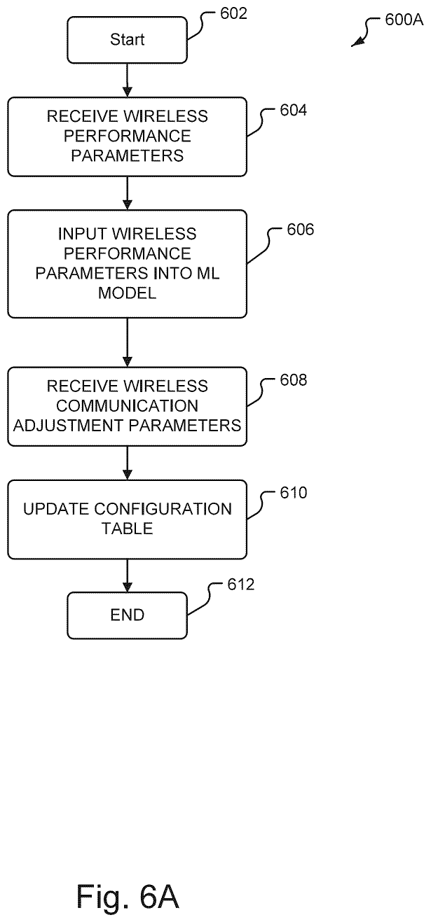

Referring now to FIG. 5A, a workload classification and routing table 502 is illustrated in accordance with aspects of the present disclosure. The workload classification and routing table 502 may be implemented within the wireless communication control system described with reference to FIG. 2 and may be utilized by the controller to determine appropriate routing strategies and wireless configuration adjustments for various workloads within the data center environment.

The workload classification and routing table 502 comprises multiple fields organized in a tabular format, with each row representing a distinct workload and each column representing specific attributes or decision parameters associated with the workloads. The table 502 enables the systematic tracking and management of communication resources based on workload characteristics and priority levels, thereby facilitating the self-optimizing nature of the wireless communication framework described herein. Although illustrated as a tabular structure, it should be understood that other data structures and organization may be utilized.

In the illustrated embodiment, the workload classification and routing table 502 includes a “WORKLOAD ID” filed, which provides a unique identifier for each data transfer session or application-level transaction within the data center. For example, the table 502 shows entries for workloads identified as “WL-001,” “WL-002,” and “WL-003,” each representing different communication sessions occurring within the data center environment. The “WORKLOAD ID” may be assigned when a communication session is initiated and may persist throughout the duration of the workload's lifecycle, enabling consistent tracking and management of resources allocated to that particular workload.

Adjacent to the Workload ID field are the “SOURCE NODE” and destination node fields, which indicate the specific endpoints involved in the communication path for each workload. The “SOURCE NODE” field identifies the originating component of the data traffic, while the Destination Node field specifies the target component receiving the transmitted data. For instance, in the first row of table 502, “Server-A” is designated as the “SOURCE NODE” and “Server-B” as the “DEST NODE” for workload “WL-001.” Similarly, workload “WL-002” involves communication between “Server-C” and “Storage-1,” while workload “WL-003” represents a connection between “Server-E” and “Server-F.” These node designations may correspond to specific physical servers, storage devices, or processing clusters within the data center fabric as described in relation to the computing environment 400 of FIG. 4A.

The “TRAFFIC TYPE” field categorizes the nature of the data being transmitted for each workload, providing context for determining appropriate resource allocation and routing decisions. This categorization enables workload-aware optimization by differentiating between various types of network traffic based on their operational characteristics. As illustrated in table 502, workload “WL-001” is classified as “App Sync” traffic, which may represent synchronization operations between application instances that typically exhibit latency-sensitive characteristics. Workload “WL-002” is identified as “Backup” traffic, potentially indicating data backup operations that may prioritize throughput reliability over immediate delivery. Workload “WL-003” is categorized as “Video Streaming” traffic, which typically requires consistent bandwidth and moderate latency tolerance. The classification of traffic types enables the wireless communication control system to apply appropriate treatment to different data flows based on their inherent characteristics and operational requirements.

The “PRIORITY LEVEL” field indicates the relative importance assigned to each workload, which may influence resource allocation decisions and routing preferences. In the illustrated example, workload “WL-001” is designated as “High” priority, workload “WL-002” as “Low” priority, and workload “WL-003” as “Medium” priority. These priority designations may be derived from several sources, including predefined application-level metadata, user-defined policies, service level agreements, or through analysis of the workload characteristics by the machine-learning model described in relation to FIGS. 2A-3 .

The “LATENCY REQUIREMENT” field specifies the maximum acceptable delay for each workload, expressed in milliseconds (ms). For high-priority workload “WL-001,” a stringent latency requirement of “5 ms” is specified, indicating that this workload is particularly sensitive to delays. In contrast, the low-priority workload “WL-002” has a more relaxed latency requirement of “50 ms,” while the medium-priority workload “WL-003” specifies an intermediate requirement of “15 ms.” These latency specifications serve as operational constraints that the wireless communication control system aims to satisfy when allocating resources and selecting communication paths.

The bandwidth requirement (BW REQ) field quantifies the data throughput needs for each workload, expressed in gigabits per second (Gbps). The high-priority workload “WL-001” requires substantial bandwidth of “10 Gbps,” while the low-priority workload “WL-002” specifies a more modest requirement of “2 Gbps.” The medium-priority workload “WL-003” indicates an intermediate bandwidth requirement of “4 Gbps.” These bandwidth specifications provide guidance to the wireless communication control system when allocating frequency resources, selecting modulation schemes, and determining channel assignments to ensure that each workload receives sufficient data-carrying capacity.

Based on the combined attributes of priority, latency requirements, and bandwidth needs, each workload in table 502 is assigned to a Quality-of-Service (QoS) Class, as indicated in the “QOS CLASS” field. The high-priority workload “WL-001” is assigned to the “Gold” QoS class, signifying the highest level of service commitment. The medium-priority workload “WL-003” is designated for the “Silver” QoS class, representing an intermediate service level, while the low-priority workload “WL-002” is allocated to the “Bronze” QoS class, indicating a basic service level. These QoS classifications may be used by the wireless communication control system to implement appropriate queuing strategies, resource reservation mechanisms, and performance monitoring thresholds for different workloads. The QoS class designations support service tiering within the data center environment, where higher-tier classes may receive preferential treatment such as higher-order modulation schemes, priority scheduling, and transmission paths with lower interference characteristics.

The “SELECTED ROUTE” field indicates the communication medium chosen for each workload based on its characteristics and current network conditions. In the illustrated example, the high-priority, low-latency workload “WL-001” is routed through a “Wired” connection, which may provide more deterministic performance characteristics suitable for demanding applications. In contrast, both the medium-priority workload “WL-003” and the low-priority workload “WL-002” are routed through “Wireless” connections, potentially leveraging the flexibility and resource efficiency of wireless communications for less latency-sensitive traffic. The routing decisions reflected in table 502 may be dynamically updated based on changing network conditions, workload characteristics, or operational priorities.

The “POLICY SOURCE” field identifies the decision-making mechanism that determined the routing selection for each workload and providing hybrid control strategies within the wireless communication system. For workloads “WL-001” and “WL-003,” the table indicates “ML INFERENCE” as the policy source, suggesting that the routing decisions were derived from the machine-learning model described in relation to FIGS. 2A-3. For workload “WL-002,” the policy source is specified as “POLICY ENGINE,” indicating that the routing decision was based on predefined rules or policies rather than adaptive machine-learning inference. This hybrid decision-making approach leverages both deterministic policy enforcement and adaptive learning-based optimization, providing the wireless communication control system with flexibility in responding to diverse workload requirements. The distinction between ML-driven and policy-driven decisions allows the system to apply AI-based optimization where appropriate while maintaining deterministic fallback policies for certain workload types or operational scenarios.

In some aspects, the workload classification and routing table 502 maintains a direct relationship with subsequent link assignment tables (not shown in FIG. 5A) that may define specific wireless parameters for each workload. Based on a workload's classification in table 502, the system may select appropriate wireless or wired paths, allocate bandwidth resources, determine modulation schemes and frequencies, and activate or deprioritize specific communication links. This integrated approach ensures consistent management of network resources across different operational layers within the data center environment.

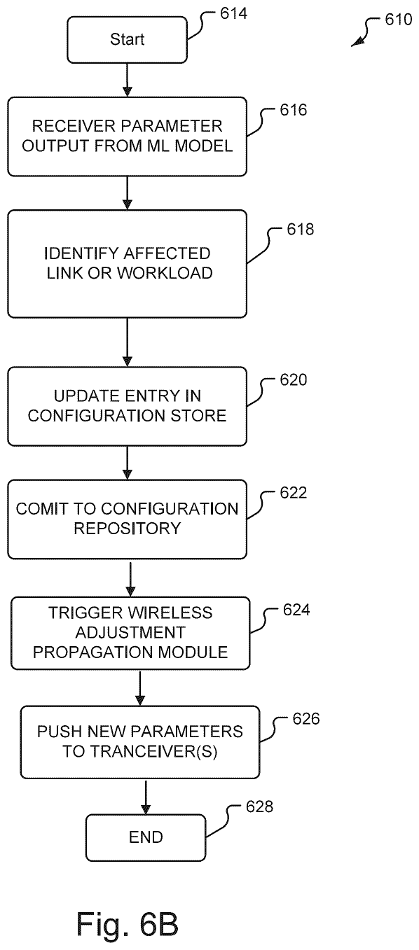

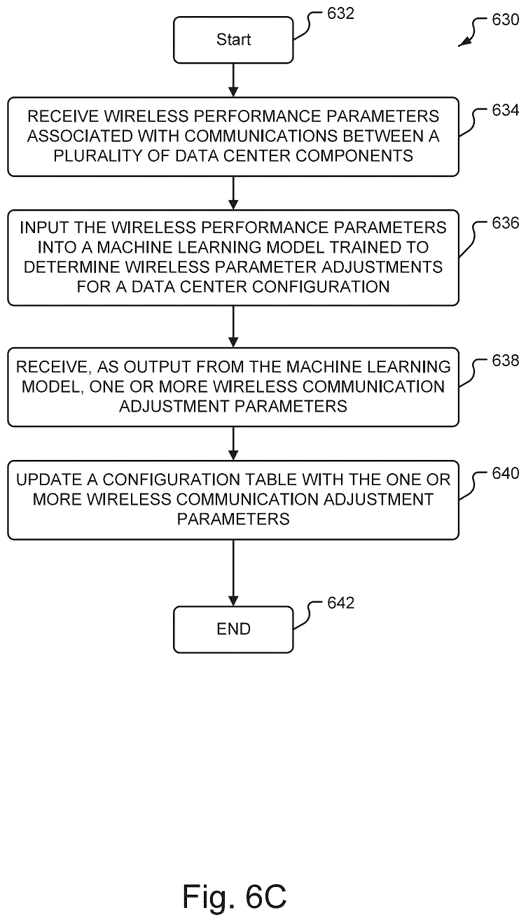

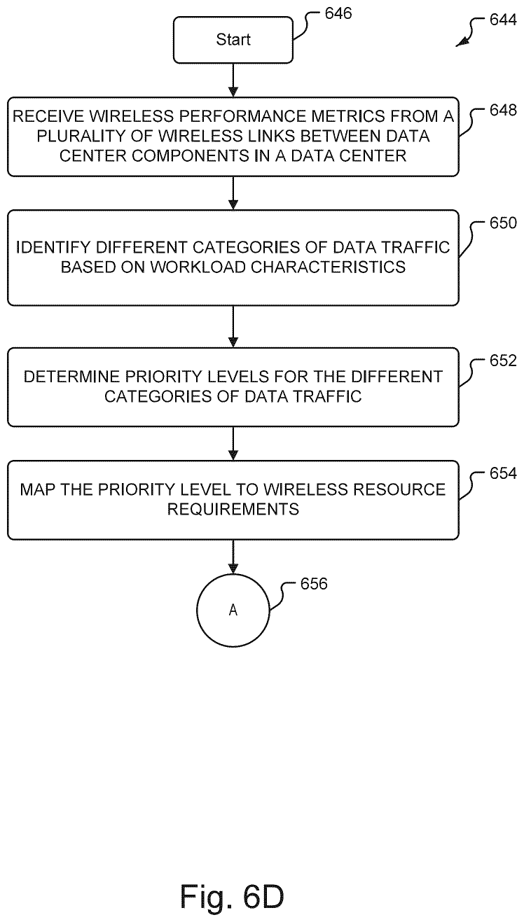

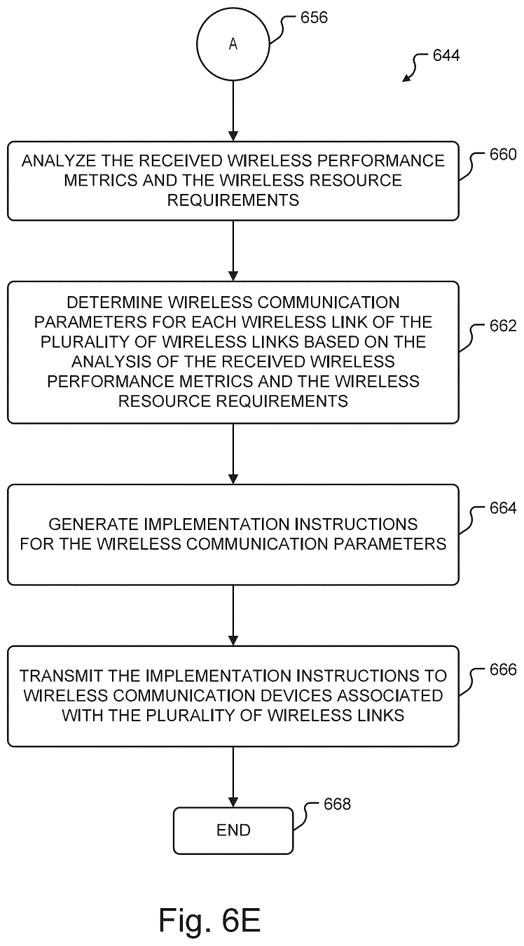

During real-time operation, the workload classification and routing table 502 may serve multiple functional roles within the self-optimizing wireless communication framework. The workload classification and routing table 502 may provide input data for the machine-learning model 208 described in FIG. 2, allowing the machine-learning model 208 to incorporate workload metadata alongside wireless performance metrics when making optimization decisions. The table 502 may also inform routing policy inference processes described in relation to FIGS. 6A-6C, influencing which communication paths receive optimization priority or rerouting considerations. Additionally, during configuration update processes as depicted in FIG. 6B, the workload classifications maintained in table 502 may be used to map parameter changes back to specific data flows or node pairs, enabling targeted optimization of wireless resources.

In certain implementations, the workload classification and routing table 502 may also support training or refinement of the machine-learning model. Historical workload classification data, including the selected routes and associated performance outcomes, may serve as labeled training examples for supervised learning approaches, as described in relation to FIG. 3A. In this context, the desired outcomes for specific workload types, such as routing selections and QoS parameters, may become training targets based on observed historical performance.

The workload classification and routing table 502 may be a dynamic data structure that may be updated as new workloads are initiated, existing workloads terminate, or operational conditions change within the data center environment. The information in this table provides contextual information for network-level decisions and application-level requirements, enabling the wireless communication control system to understand workload requirements, route traffic along optimal paths, coordinate between machine-learning inference and policy-based decision-making, and dynamically tune network parameters to meet service guarantees. Through this systematic classification and routing approach, the self-optimizing wireless communication framework can efficiently allocate resources, select appropriate communication paths, and adjust wireless parameters to maintain optimal performance across diverse workload types.

Referring now to FIG. 5B, a link configuration table 504 is illustrated in accordance with aspects of the present disclosure. The link configuration table 504 depicts operational characteristics and parameters for a plurality of wired and wireless communication links within a data center environment. In some implementations, the link configuration table 504 may be maintained by the wireless communication control system described with reference to FIG. 2, where the configuration management module 210 stores the parameter settings that are determined by the machine-learning model 208 and distributed by the wireless adjustment propagation module 212. In some aspect, the link configuration table 504 may enables systematic tracking, management, and optimization of wireless and wired communication resources based on operational requirements, workload characteristics, and real-time performance metrics.

The link configuration table 504 may include multiple fields organized in a tabular structure, with each row representing a discrete communication link and each column representing specific configuration parameters or attributes associated with that link. This structured approach facilitates efficient storage, retrieval, and modification of link-specific parameters during the self-optimization process. The comprehensive information contained within the link configuration table 504 serves as both a record of current operational states and a repository of configuration data that can be accessed and modified by various components of the wireless communication control system. Although illustrated as a tabular structure, it should be understood that other data structures and organization may be utilized.

In some aspects, the link configuration table 504 may include a “LINK ID” field, which provides a unique identifier for each communication link within the data center infrastructure. The table 504 shows entries for wireless links identified as “WL-1001”, “WL-1002”, and “WL-1003”, and a wired link identified as “WD-2001”. These identifiers provide a reference to specific links throughout the system, facilitating targeted configuration updates and performance monitoring.

In some aspects, the link configuration table 504 may include a “LINK TYPE” field, which classifies each communication path according to its physical implementation. In the illustrated example, links “WL-1001”, “WL-1002”, and “WL-1003” are designated as “Wireless”, indicating that these connections utilize wireless transmission technologies such as millimeter wave or terahertz frequencies. Link “WD-2001” is classified as “Wired (optical)”, signifying a physical connection using fiber optic cabling. The link type classification enables the wireless communication control system to apply appropriate optimization strategies based on the physical characteristics and capabilities of each link type.

In some aspects, the link configuration table 504 may include a “CONNECTED NODES” field that identifies one or more endpoints or components interconnected by each communication link. For example, link “WL-1001” connects “Server-A” to “Server-D”, as denoted by the syntax “Server-A<->Server-D”, where the bidirectional arrow indicates that communication can flow in either direction between these nodes. Similarly, link “WL-1002” connects “Server-B” to “Server-E”, link “WD-2001” connects “Server-C” to “Storage-1”, and link “WL-1003” connects “VM-Group-X” to “DB-Node-3”.

In some aspects, the link configuration table 504 may include a “TRAFFIC TYPE” field categorizing the nature of data being transmitted over each link and providing context for determining appropriate configuration parameters and quality-of-service requirements. In the illustrated example, link “WL-1001” carries “App Sync” traffic, which may represent synchronization operations between application instances that typically exhibit specific characteristics such as bursty transmission patterns and sensitivity to latency. Links “WL-1002” and “WD-2001” both carry “Backup” traffic, potentially representing data backup operations that may prioritize throughput over latency. Link “WL-1003” is designated for “Video Streaming” traffic, which typically requires consistent bandwidth allocation and moderate latency characteristics. These traffic type classifications enable the wireless communication control system to configure link parameters in a manner that aligns with the specific requirements of different data flows.

In some aspects, the link configuration table 504 may include an “ALLOCATED BW” field that specifies the bandwidth capacity currently assigned to each communication link, expressed in gigabits per second (Gbps). For instance, link “WL-1001” is allocated “8 Gbps” of bandwidth, link “WL-1002” is allocated “2 Gbps”, link “WD-2001” is allocated “10 Gbps”, and link “WL-1003” is allocated “5 Gbps”. These bandwidth allocations reflect decisions made by the wireless communication control system regarding resource distribution across the network, potentially based on factors such as workload priority, traffic demands, and available capacity. The variation in allocated bandwidth across different links demonstrates the system's capability to tailor resource assignments based on specific requirements rather than applying uniform allocations.

For wireless links, the link configuration table 504 may include several additional parameters that reference their radio frequency characteristics. The “FREQ” field indicates the approximate frequency band utilized for wireless transmission, such as “60 GHz” for link “WL-1001”, “24 GHz” for link “WL-1002”, and “124 GHz” for link “WL-1003”. These frequency selections may be determined by the machine-learning model based on factors such as required bandwidth, propagation characteristics, interference patterns, and distance between connected nodes. Higher frequency bands such as 124 GHz or 245 GHz may offer greater bandwidth capacity but potentially shorter range, while lower frequency bands such as 28 GHz may provide better propagation characteristics but potentially lower bandwidth. The frequency assignments across different wireless links enable optimization of spectral resources based on specific link requirements.

The “MOD. SCHEME” field specifies the modulation technique employed for encoding data on each wireless link. In the illustrated example, link “WL-1001” utilizes “128-QAM” (Quadrature Amplitude Modulation), which represents a higher-order modulation scheme capable of encoding multiple bits per symbol, potentially enabling higher data rates at the cost of requiring better signal quality. Link “WL-1002” employs “QPSK” (Quadrature Phase Shift Keying), a more robust but lower-capacity modulation scheme that may be suitable for links with challenging signal conditions or lower bandwidth requirements. Link “WL-1003” uses “16-QAM”, representing an intermediate modulation complexity. The variation in modulation schemes across different wireless links allows the system to adapt encoding techniques based on link-specific conditions and requirements.

The “TX PW” field indicates the transmission power level configured for each wireless link, expressed in decibel-milliwatts (dBm). For example, link “WL-1001” operates at “18 dBm”, link “WL-1002” at “12 dBm”, and link “WL-1003” at “15 dBm”. These power settings may be dynamically determined by the machine-learning model to maintain adequate signal quality at the receiver while minimizing energy consumption and potential interference with other wireless links. Higher power levels may be assigned to links requiring greater range or operating in challenging environments, while lower power levels may be sufficient for shorter-distance links or those operating in less congested spectral conditions.

The “ASSIGNED WORKLOAD” field maps active workloads to their corresponding communication links, establishing a relationship between the workload classification data described with reference to FIG. 5A and the physical or logical links carrying that workload traffic. In the illustrated example, link “WL-1001” is assigned workloads “WL-001” and “WL-003”, link “WL-1002” is assigned workload “WL-004”, link “WD-2001” is assigned workload “WL-002”, and link “WL-1003” is assigned workload “WL-005”. This mapping enables the wireless communication control system to track how communication resources are being utilized to support specific operational tasks and to make informed decisions regarding resource allocation and optimization.

The “ACTIVE STATUS” field indicates the current operational state of each communication link. In the illustrated example, links “WL-1001”, “WL-1002”, and “WD-2001” are marked as “Active”, indicating that these links are currently operational and carrying traffic. Link “WL-1003” is marked as “Standby”, suggesting that this link is configured but not currently in active use, potentially serving as a backup or overflow capacity that can be activated when needed. This status information allows the wireless communication control system to monitor available capacity, track resource utilization, and make informed decisions regarding link activation or deactivation based on changing network conditions and requirements.

The “UPDATED VIA ML” field indicates whether the current configuration of each link has been determined or modified through machine-learning inference, as described with reference to FIGS. 2A-3. In the illustrated example, links “WL-1001”, “WL-1002”, and “WD-2001” are marked as “Yes”, indicating that their current parameters were established or adjusted based on recommendations from the machine-learning model. Link “WL-1003” is marked as “Standby” in this field, consistent with its operational status, suggesting that machine-learning optimization may not be actively applied to links that are not in operational use. In some aspects, indicating whether a link has been determined or modified through machine-learning inference may provide traceability regarding the source of configuration decisions and may be useful for evaluating the effectiveness of machine-learning-based optimizations compared to alternative configuration approaches.

During operation, the link configuration table 504 may be used as a central reference for various components of the wireless communication control system. The wireless performance monitoring module 206 described with reference to FIG. 2 may compare actual performance metrics against the configured parameters stored in this the link configuration table 504 to identify potential optimization opportunities. The machine-learning model may use the current configuration data as part of its input when generating new parameter recommendations. The wireless adjustment propagation module 212 of FIG. 2A may reference the link configuration table 504 when determining which parameters need to be updated and distributed to specific devices within the data center.

In certain implementations, the link configuration table 504 may be dynamically updated as network conditions change, workload requirements evolve, or new optimization opportunities are identified by the machine-learning model (e.g., machine-learning model 208 of FIG. 2A). These updates may involve adjustments to frequency assignments, modulation schemes, transmit power levels, bandwidth allocations, or other parameters to maintain optimal performance across diverse operating conditions. The timestamps or version information associated with these updates may be tracked to enable historical analysis and evaluation of optimization effectiveness over time.

In some implementations, while the link configuration table 504 illustrated in FIG. 5B depicts several key parameters used for wireless link configuration, it should be understood that additional parameters may be tracked, stored, and managed within the wireless communication control system described herein. These additional parameters may include, but are not limited to, antenna beam identifiers that specify directional transmission patterns, antenna identifiers that designate specific physical or virtual antenna elements, spatial stream configurations for MIMO implementations, coding schemes that complement the modulation techniques, guard interval settings, channel bonding configurations, spatial multiplexing parameters, interference mitigation coefficients, and adaptive rate control thresholds. The specific parameters maintained within the configuration tables may vary based on the particular wireless technologies implemented, the physical characteristics of the data center environment, and/or the optimization objectives prioritized by the system. The configuration management module 210 described with reference to FIG. 2A may maintain parameter sets that extend beyond those explicitly depicted in the exemplary tables shown in the figures, enabling fine-grained control over wireless link behavior and performance in response to changing conditions within the data center environment.

In some aspects, the link configuration table 504 may implement a hierarchical organization that establishes parameter profiles optimized for different communication scopes within the data center environment. For pod-to-pod communications that span longer distances across multiple rows of racks, the link configuration table 504 may maintain one or more parameter settings that are directed to long-range transmissions, including lower-frequency band assignments that offer superior propagation characteristics, modulation schemes with enhanced error correction capabilities, and higher transmission power profiles balanced against potential interference impacts. For rack-to-rack communications occurring within closer proximity, the link configuration table 504 may reference intermediate-range parameter profiles that balance throughput capacity with spatial reuse efficiency, including mid-band frequency allocations, moderate modulation complexity, and optimized beamforming parameters tailored to typical inter-rack distances and obstacles. For tray-to-tray communications within individual racks, the link configuration table 504 may implement short-range, high-efficiency parameter settings that rely on the controlled signal environment, including high-frequency millimeter wave bands that offer maximum bandwidth, modulation schemes that maximize spectral efficiency, and low-power transmission profiles to minimize energy consumption while maintaining reliability.

Referring now to Fig. conf, a wireless link performance table 506 is depicted in accordance with aspects of the present disclosure. In some aspects, the wireless link performance table 506 characterizes physical-layer parameters and signal quality metrics of multiple wireless communication links established between server nodes within a data center environment. The wireless link performance table 506 may be maintained by the wireless performance data collection component 204 described with reference to FIG. 2A and may serve as input for the wireless performance monitoring module 206 and machine-learning model 208 to enable dynamic optimization of wireless parameters.

In some aspects, the wireless link performance table 506 comprises multiple fields organized in a tabular structure, with each row representing a distinct wireless communication link and each column representing specific performance metrics or configuration parameters associated with that link. This structured approach enables efficient monitoring and analysis of wireless link conditions throughout the data center environment. Although illustrated as a tabular structure, it should be understood that other data structures and organization may be utilized.

In the illustrated aspect, the wireless link performance table 506 includes a “LINK ID” field, which provides a unique identifier for each wireless communication link within the data center infrastructure. The wireless link performance table 506 depicts entries for wireless links identified as “WL-1001”, “WL-1002”, “WL-1003”, and “WL-1004”. These identifiers enable unambiguous reference to specific links throughout the system.

Adjacent to the “LINK ID” field are the “SOURCE NODE” and “DEST. NODE” fields, which identify the specific endpoints connected by each wireless link. These fields provide the topological context for understanding the spatial relationships between communicating components. For example, link “WL-1001” connects “Server-A” to “Server-B”, link “WL-1002” connects “Server-C” to “Server-D”, link “WL-1003” connects “Server-E” to “Server-E”, and link “WL-1004” connects “Server-F” to “Server-F”. The source and destination information may be used by the machine-learning model 208 to correlate performance metrics with physical distances, obstruction patterns, or potential interference sources within the data center layout.

The “FREQ. BAND” field specifies the carrier frequency utilized for each wireless link, expressed in gigahertz (GHz). For instance, link “WL-1001” operates at “60 GHz”, link “WL-1002” at “24 GHz”, link “WL-1003” at “124 GHz”, and link “WL-1004” at “245 GHz”. These frequency selections may span multiple bands within the millimeter wave spectrum, providing the system with flexibility to operate across different frequency ranges based on specific requirements and environmental conditions. The frequency band selection may influence factors such as bandwidth capacity, propagation characteristics, and susceptibility to interference. Higher frequency bands such as 124 GHz and 245 GHz may offer greater bandwidth capacity but potentially reduced range or increased susceptibility to physical obstructions, while lower frequency bands like 24 GHz may provide better propagation characteristics through obstacles but potentially lower total bandwidth. The machine-learning model 208 may dynamically recommend shifts in operating frequency based on observed performance patterns and predicted interference scenarios.

The “CHANNEL WIDTH” field indicates the spectral bandwidth allocated to each wireless link, expressed in megahertz (MHz). For example, link “WL-1001” utilizes a channel width of “2000 MHz”, link “WL-1002” uses “800 MHz”, link “WL-1003” employs “1600 MHz”, and link “WL-1004” operates with “2400 MHz”. These channel width allocations represent the system's allocation of spectral resources based on bandwidth requirements, priority levels, and available spectrum within each frequency band. Wider channels generally enable higher data throughput but consume more of the available spectrum, potentially limiting the number of concurrent links that can operate without interference in a given area. The variation in channel widths across different links demonstrates the system's capability to tailor bandwidth allocations based on specific requirements rather than applying uniform allocations.

The “MOD. SCHEME” field specifies the modulation technique employed for encoding data on each wireless link. In the illustrated example, link “WL-1001” utilizes “128-QAM.” Link “WL-1002” employs “16-QAM”, a moderate modulation complexity suitable for balanced performance between data rate and signal robustness. Link “WL-1003” uses “QPSK.”. Link “WL-1004” implements “BPSK.” The machine-learning model 208 may dynamically adjust modulation schemes based on observed signal quality metrics, adapting to changing conditions to maintain optimal performance.

The “TX PW” field indicates the transmission power level configured for each wireless link, expressed in decibel-milliwatts (dBm). For example, link “WL-1001” operates at “18 dBm”, link “WL-1002” at “15 dBm”, link “WL-1003” at “20 dBm”, and link “WL-1004” at “10 dBm”. These power settings may be dynamically determined by the machine-learning model 208 to maintain adequate signal quality at the receiver while minimizing energy consumption and potential interference with other wireless links. Higher power levels may be assigned to links requiring greater range or operating in challenging environments, while lower power levels may be sufficient for shorter-distance links or those operating in less congested spectral conditions. The machine-learning model 208 may continually optimize these power levels based on observed performance metrics and changing environmental conditions.

The “ANT BEAM ID” field identifies specific beamforming configurations implemented for each wireless link, such as “Beam-3” for link “WL-1001”, “Beam-1” for link “WL-1002”, “Beam-2” for link “WL-1003”, and “Beam-4” for link “WL-1004”. These beam identifiers may correspond to predefined or dynamically configured antenna patterns that focus transmitted energy in specific directions to improve signal strength at the intended receiver while reducing interference with other links. Directional beamforming represents a spatial dimension of wireless resource management, complementing the frequency, bandwidth, and modulation parameters to enable efficient spectrum utilization within the dense data center environment. The machine-learning model 208 may recommend adjustments to beamforming patterns based on observed interference patterns and physical layout changes within the data center.

The “LINK QUALITY (SNR)” field quantifies the signal-to-noise ratio measured for each wireless link, expressed in decibels (dB). For instance, link “WL-1001” exhibits an SNR of “35 dB”, link “WL-1002” shows “29 dB”, link “WL-1003” reports “27 dB”, and link “WL-1004” indicates “22 dB”. These measurements provide a direct assessment of the signal quality experienced by each link, with higher values generally corresponding to more reliable connections capable of supporting higher-order modulation schemes and greater throughput. The SNR values serve as key performance indicators that may trigger adaptive responses from the machine-learning model 208 when they fall below thresholds associated with reliable operation for the configured modulation schemes. The SNR measurements may be collected periodically through specialized probe packets or extracted from normal data traffic, providing continuous feedback on link performance.

The “CURRENT STATUS” field indicates the operational state of each wireless link. In the illustrated example, links “WL-1001” and “WL-1002” are marked as “Active”, indicating that these links are currently operational and carrying traffic. Link “WL-1003” is marked as “Standby”, suggesting that this link is configured but not currently in active use, potentially serving as a backup or overflow capacity that can be activated when needed. Link “WL-1004” is designated as “Degraded”, indicating that this link is operational but experiencing suboptimal performance conditions that may require attention or parameter adjustments. The status information allows the wireless communication control system to monitor the health of the wireless network, identify links requiring intervention, and make informed decisions regarding link activation, deactivation, or reconfiguration based on changing network conditions and requirements.

During runtime operation, the wireless performance monitoring module 206 may analyze the metrics contained in the wireless link performance table 506 to identify trends, anomalies, or performance degradations that warrant attention. When specific conditions are detected, such as declining SNR values, the wireless performance monitoring module 206 may trigger the machine-learning model 208 to generate updated parameter recommendations. These recommendations may then be propagated to the affected wireless devices through the wireless adjustment propagation module 212, completing the closed-loop optimization process. The performance metrics captured in the wireless link performance table 506 may also serve as training data for refining the machine-learning model 208 over time, enabling the system to learn from operational patterns and improve its optimization strategies.

In certain implementations, the wireless link performance table 506 may be updated at regular intervals or in response to significant events, providing a time-series record of performance characteristics that can reveal trends, cyclical patterns, or correlations with specific workload conditions. This historical performance data may improve the predictive capabilities of the machine-learning model 208 by, for example, enabling proactive parameter adjustments in anticipation of known traffic patterns or recurring conditions within the data center environment.

In various implementations, the wireless link performance table 506 shown in FIG. 5C represents a non-exhaustive subset of the performance metrics and parameters that may be monitored within the self-optimizing wireless communication framework. Additional metrics that may be tracked include, but are not limited to, packet error rates, frame retry counts, average and peak throughput values, channel utilization percentages, interference-to-noise ratios, multipath delay spread measurements, Doppler shift indicators (for environments with mobile elements), received signal strength indicators (RSSI) across multiple antenna elements, effective isotropic radiated power (EIRP) measurements, adjacent channel power ratios, error vector magnitude (EVM) readings for signal quality assessment, frequency offset measurements, phase noise measurements, and timing synchronization metrics. The wireless performance data collection component 204 may be configured to gather these and other relevant metrics at configurable intervals or in response to specific trigger events. The granularity and scope of performance monitoring may be dynamically adjusted based on system requirements, troubleshooting needs, or resource constraints within the data center environment.

In various implementations, the wireless communication control system may implement communication pattern monitoring to identify data center components that frequently exchange data and optimize wireless parameters specifically for these high-traffic relationships. The system may collect and analyze traffic flow statistics between component pairs, including metrics such as connection frequency, data volume transferred, session duration, and temporal patterns of communication. Using statistical analysis and pattern recognition techniques, the system identifies component pairs that exhibit sustained high-volume data exchange or consistently recurring communication patterns. These identified pairs may be classified as “frequently communicating components” and recorded in a component affinity table that tracks their relationship strength and communication characteristics. For these component pairs, the wireless communication control system may implement parameter optimizations including dedicated frequency channel allocations that minimize contention with other network traffic, preferential bandwidth assignments that ensure sufficient capacity for their communication needs, optimized beam steering parameters that create focused transmission paths between the components, and custom modulation schemes tailored to their specific signal quality conditions. The machine-learning model 208 may incorporate communication pattern data as an additional input feature, enabling it to prioritize link quality for frequently communicating pairs when generating wireless parameter recommendations. By recognizing and adapting to these natural communication relationships within the data center environment, the system maintains an optimal performance for the most important data flows while efficiently allocating remaining wireless resources across other network paths.

Referring now to FIG. 6A, a flowchart of a method 600A for managing wireless communication parameters in a data center network using machine-learning inference is illustrated in accordance with various aspects of the present disclosure. The method 600A may be implemented by one or more control components within the wireless communication control system 200 described with reference to FIG. 2A, such as the wireless performance monitoring module 206, machine-learning model 208, and wireless adjustment propagation module 212. The method 600A depicts at least one process for dynamically adjusting wireless parameters in response to changing data center conditions without requiring manual intervention.

The method 600A begins at block 602, which represents a start condition for the parameter optimization process. In various implementations, the start condition at block 602 may be triggered by different events or schedules, such as the initiation of a predetermined monitoring interval, the detection of a significant workload change within the data center environment, the identification of performance degradation on one or more wireless links, or a scheduled configuration update based on operational policies. The start condition may also be triggered by specific events such as the addition of new hardware components, physical reconfiguration of the data center environment, or detection of new interference sources. In some aspects, the start condition may be part of a continuous monitoring and optimization loop, where the process automatically restarts after completion to ensure ongoing adaptation to changing conditions.

In some aspects, at block 604, the system may receive wireless performance parameters associated with communications between data center components. These wireless performance parameters may comprise quantitative metrics that characterize the quality and efficiency of wireless communications throughout the data center environment. The wireless performance parameters may include, but are not limited to, signal-to-noise ratio (SNR) measurements that indicate the clarity of wireless signals relative to background noise, throughput metrics that quantify the data transfer rates achieved across various links, bit error rates that reflect the reliability of data transmission, latency values that measure the time required for data to traverse the network, packet loss statistics that identify instances of failed data delivery, modulation efficiency indicators that assess the effectiveness of current encoding schemes, interference levels detected across different frequency bands, and antenna beam alignment metrics that track the precision of directional transmissions.

In various implementations, these wireless performance parameters may be collected by telemetry agents embedded in interconnect devices (such as wireless-enabled switches as described with reference to FIG. 4B) or endpoint nodes (such as servers or storage systems). In some aspects, alternative collection methods may include dedicated monitoring appliances positioned throughout the data center that passively observe wireless communications without participating in data transmission, specialized probe packets injected into the network that measure performance characteristics along specific paths, distributed sensors that detect radio frequency characteristics independently of the communication devices themselves, or through software-defined networking (SDN) controllers that aggregate performance data from multiple network layers. The collection process may operate continuously or at configurable intervals, with parameters potentially aggregated at different timescales ranging from millisecond-level sampling for metrics to minute-level or hour-level aggregation for trend analysis. The wireless performance parameters may be transmitted to centralized monitoring components through dedicated management channels, in-band telemetry mechanisms, or specialized monitoring protocols designed to minimize overhead on production traffic. In some aspects, the collection process may implement statistical preprocessing techniques such as filtering, normalization, or aggregation to reduce data volume while preserving some information for subsequent analysis.

At block 606, the system inputs the wireless performance parameters into a machine-learning model. The machine-learning model may correspond to the machine-learning model 208 described with reference to FIG. 2A and may be pre-trained using historical datasets of wireless performance metrics paired with corresponding optimal configuration settings. The machine-learning model may be configured to analyze current performance data and infer optimal wireless configuration parameters based on observed environmental conditions, workload characteristics, and operational constraints. The processing at block 606 involves transforming the raw performance metrics into a structured input format compatible with the machine-learning model's architecture, such as feature vectors or multi-dimensional tensors that preserve the relationships between different metrics and their temporal evolution.

In various implementations, the machine-learning model may be implemented using various algorithmic approaches, including but not limited to neural network architectures as described with reference to FIG. 3B, decision tree ensembles that capture complex decision boundaries, support vector machines that identify optimal parameter spaces, or reinforcement learning systems that improve recommendations through iterative feedback. The input processing at block 606 may also incorporate contextual information beyond the direct performance metrics, such as data center topology information, workload schedules, priority classifications, or historical performance patterns that provide additional context for the inference process. In some aspects, the machine-learning model may implement ensemble techniques that combine multiple specialized models, each optimized for particular aspects of wireless parameter adjustment, with their outputs aggregated through weighted voting or hierarchical decision processes.

At block 608, the system may receive wireless communication adjustment parameters as output from the machine-learning model. These adjustment parameters may represent the machine-learning model's determination of optimal configuration settings based on the current performance data and operational context. The wireless communication adjustment parameters may include, but are not limited to, recommended transmit power levels for individual transceivers, suggested frequency band allocations that minimize interference between adjacent links, proposed modulation scheme adjustments that balance data rate against link reliability, antenna beam direction modifications that improve spatial separation between wireless links, bandwidth allocation recommendations that align resource distribution with workload priorities, channel selection guidance that navigates around detected interference sources, and quality of service (QoS) class assignments that ensure appropriate treatment of different traffic types.

In various implementations, the output parameters at block 608 may be accompanied by confidence scores or uncertainty metrics that indicate the machine-learning model's certainty in its recommendations, enabling risk-aware decision making when applying changes to production environments. The adjustment parameters may be constrained based on policy rules encoded in the configuration management module 210 described with reference to FIG. 2A, or physical layer capabilities documented in device profiles, ensuring that the recommended changes remain within operationally safe and technically feasible boundaries. The output format may be structured to facilitate direct implementation in network devices or may include human-readable explanations when manual approval is required for significant parameter changes.

At block 610, the system updates a configuration table with the wireless communication adjustment parameters received from the machine-learning model. The configuration table may correspond to the link configuration table 504 described with reference to FIG. 5B, which maps specific wireless links to their operational parameters. The configuration table may be stored in a centralized control repository managed by the configuration management module 210 described with reference to FIG. 2A, or may be distributed across multiple management components for redundancy and locality of access. The update process at block 610 involves systematically modifying the parameter values associated with affected wireless links, and may include version tracking, change validation, and conflict resolution when multiple updates target the same configuration elements.

In various implementations, the updates to the configuration table may be staged through a multi-phase commit process that ensures consistency across distributed components, with changes first marked as pending, then verified for compatibility, and finally committed to active status when all validation checks have passed. The update operation may generate change logs for audit purposes, recording which parameters were modified, the rationale for the changes (derived from the machine-learning model's analysis), and the expected performance improvements. In some aspects, the configuration table may maintain both current and historical parameter values to enable rollback capabilities if newly applied changes produce unexpected outcomes. The update process may implement access control mechanisms that restrict modification privileges based on security policies, ensuring that authorized components or operators can alter wireless parameters.

Following the update of the configuration table at block 610, the configuration changes may be propagated to the affected wireless devices within the data center environment. This propagation process, though not explicitly depicted in FIG. 6A, may involve translating the abstract parameter specifications into device-specific configuration commands, transmitting these commands through secure management channels, and verifying successful application through acknowledgment mechanisms. The propagation may be scheduled based on operational windows, with time-sensitive parameters applied immediately while less important adjustments may be batched for efficiency. In some implementations, the system may implement canary deployment strategies, where parameter changes are initially applied to a subset of devices to validate their effects before full-scale deployment.

The method 600A terminates at block 612, which represents the completion of a single optimization cycle. In some implementations, the process depicted in FIG. 6A may operate as part of a continuous improvement loop, where the system repeatedly monitors performance, analyzes conditions, and applies targeted adjustments to maintain optimal wireless communication characteristics throughout the data center environment. The process may automatically restart at block 602 after a predetermined interval, or may be triggered by events such as the detection of significant performance changes, the introduction of new workloads, or administrator-initiated review cycles.

Referring now to FIG. 6B, a flowchart illustrating a configuration update sub-process 610 is depicted, in accordance with aspects of the present disclosure. The configuration update sub-process 610 references additional details regarding operations performed during block 610 of the method 600A described with reference to FIG. 6A. The configuration update sub-process 610 may implement one or more mechanisms for applying wireless parameter adjustments derived from machine-learning inference to operational network components within a data center environment.

The configuration update sub-process 610 may begin at block 614, which represents an entry point into the parameter configuration sequence. Block 614 may be triggered following the generation of wireless communication adjustment parameters by the machine-learning model as described with reference to block 608 of FIG. 6A. The start operation at block 614 may initialize data structures, establish logging contexts, or prepare transaction boundaries for the subsequent configuration operations. In some implementations, the start operation may verify system readiness by confirming connectivity with target devices, checking authorization credentials for configuration changes, or validating that prerequisite conditions have been satisfied. The entry point at block 614 may also establish performance metrics collection for the configuration process itself, enabling the system to track the efficiency and reliability of parameter propagation operations for continuous improvement of the management framework.

At block 616, the system receives parameter output from the machine-learning model. The parameter output received at block 616 may correspond to the wireless communication adjustment parameters generated at block 608 of FIG. 6A, now prepared for implementation within the data center environment. The parameters may encompass a comprehensive set of wireless configuration attributes designed to optimize communication performance based on current environmental conditions and operational requirements. The parameter output received at block 616 may be structured as formatted configuration objects compatible with network management protocols, or as abstract parameter representations that require translation into device-specific commands. In some implementations, the parameter output may include metadata such as confidence scores indicating the machine-learning model's certainty in its recommendations, expected performance improvements associated with each parameter change, or dependencies between different parameter adjustments that should be applied as atomic groups. The parameter output may also specify temporal aspects of the configuration, such as whether changes should be applied immediately, scheduled for specific maintenance windows, or implemented gradually to minimize service disruption.

At block 618, the system identifies the affected link or workload corresponding to the received parameter adjustments. This identification process establishes the scope and context for the subsequent configuration changes, mapping abstract parameter recommendations to specific communication paths, hardware components, or data flows within the data center environment. The identification at block 618 may utilize various reference mechanisms, such as unique link identifiers (e.g., “WL-1001”) as shown in the wireless link performance table 506 of FIG. 5C, workload identifiers (e.g., “WL-001”) as shown in the workload classification and routing table 502 of FIG. 5A, or node pair designations that specify the endpoints of the communication path (e.g., “Server-A<->Server-B”).

The identification process at block 618 may involve referencing multiple data structures to establish comprehensive context for the parameter changes. For example, the system may first identify the affected link using a physical identifier, then reference workload mapping tables to determine which data flows or applications utilize that link, allowing for impact assessment before implementing changes. In some aspects, the identification process may also determine the administrative domains or management boundaries associated with the affected links or workloads, potentially triggering additional approval workflows or notification mechanisms when changes span organizational boundaries within the data center environment. The identification process enables targeted configuration updates that minimize unnecessary reconfiguration of unaffected components, reducing potential service disruptions and conserving system resources.

At block 620, the system updates an entry in a configuration store based on the identified link or workload and the received parameter adjustments. The configuration store may represent a staging area or temporary repository where proposed changes are documented and prepared before commitment to the permanent configuration repository. The update operation at block 620 may involve creating new configuration entries for previously unconfigured links, modifying existing entries to reflect parameter adjustments, or marking obsolete entries for deprecation or removal. The configuration store may implement versioning mechanisms that maintain historical configuration states alongside proposed changes, enabling comparison, rollback capabilities, or audit functions.

In some implementations, the update operation at block 620 may trigger validation processes that verify the syntactic correctness of parameter specifications, check compliance with operational policies or regulatory constraints, and confirm compatibility with the capabilities of target devices. The configuration store may employ a structured schema that enforces data type constraints, value ranges, or relationship rules between different parameters to ensure consistency and validity of the proposed configuration. The update operation may generate change records that document the specific modifications being made, the source of those changes (e.g., machine-learning inference, policy application, or manual intervention), and the rationale or expected benefits associated with each adjustment. The records may support operational transparency, facilitate troubleshooting, and enable evaluation of the configuration management process over time.

At block 622, after validation and preparation in the configuration store, the system commits the updated parameters to a configuration repository. The configuration repository may correspond to the configuration management module 210 described with reference to FIG. 2A, serving as the authoritative source of configuration information for the wireless communication system. The commit operation at block 622 represents a transition from proposed or staged changes to officially recognized configuration specifications that are ready for distribution and implementation. The configuration repository may implement transaction semantics that ensure atomic updates, where either all related parameter changes are applied successfully or none are applied, maintaining consistency across the configuration dataset.

In some aspects, the commit operation at block 622 may trigger notification mechanisms that inform relevant stakeholders about pending configuration changes, potentially including system administrators, application owners, or automated monitoring systems. The configuration repository may implement access control mechanisms that restrict modification privileges based on authorization levels, ensuring that approved entities can alter wireless parameters. Upon successful commitment, the configuration repository may generate unique version identifiers or timestamps that allow the system to track the evolution of configuration settings over time and correlate performance changes with specific configuration updates. The configuration repository serves as a central reference point that enables consistent distribution of parameters across the data center environment, supporting both immediate propagation to active devices and provisioning of new components as they are added to the network.

At block 624, the system triggers a wireless adjustment propagation module to distribute the committed configuration parameters. The wireless adjustment propagation module may correspond to the wireless adjustment propagation module 212 described with reference to FIG. 2A, responsible for orchestrating the delivery of updated parameters to relevant network elements. The triggering operation at block 624 initiates a workflow that transforms abstract configuration specifications into concrete implementation actions, ensuring that parameter adjustments are effectively applied to operational systems. The wireless adjustment propagation module may implement scheduling algorithms that determine the timing and sequencing of configuration changes to minimize service disruption, avoid conflicting updates, or coordinate changes across interdependent components.

In some implementations, the wireless adjustment propagation module may implement different distribution strategies based on the nature and scope of the configuration changes. Adjustments addressing immediate performance issues may be propagated with high priority, while less urgent optimizations may be batched for efficiency or scheduled during low-utilization periods. The propagation module may incorporate deployment patterns such as canary releases, where changes are initially applied to a subset of devices to validate their effects before system-wide implementation. For complex updates affecting multiple interconnected components, the propagation module may orchestrate phased deployments that maintain system integrity throughout the transition. The module may also implement dependency resolution that ensures prerequisite conditions are satisfied before applying dependent configurations, such as establishing control-plane changes before modifying data-plane parameters.

At block 626, the system pushes the new parameters to one or more transceivers within the data center environment. The push operation may represent a final step in the configuration delivery process, where abstract parameter specifications are translated into device-specific commands and transmitted to the physical or virtual components responsible for implementing wireless communications. The transceivers receiving these parameters may include wireless network interfaces on servers or storage systems, wireless-enabled switches or routers as described with reference to FIG. 4, dedicated wireless access points, or specialized wireless adapters integrated into data center infrastructure. The parameter push may utilize various communication channels depending on the management architecture, such as secure management protocols (e.g., SNMP, NETCONF, or gRPC), configuration agents running on target devices, or software-defined networking controllers that centrally program network behavior.

In some aspects, the push operation at block 626 may incorporate verification mechanisms that confirm successful receipt and application of the parameters by the target transceivers. The verification mechanisms may include acknowledgment messages returned by the devices, post-configuration diagnostic tests that validate parameter application, or performance measurements that confirm the expected effects of the adjustments. For some systems, the push operation may implement fallback procedures that automatically revert to previous configurations if verification fails or if negative performance impacts are detected following parameter application. The push operation may also update local state information on the target devices, ensuring that their internal configuration repositories accurately reflect the centrally managed parameters. Through this final push operation, the wireless communication parameters determined through ‘machine-learning inference are physically implemented within the data center environment, completing the transition from analytical insights to operational improvements.

The configuration update sub-process 610 concludes at block 628, which represents the completion of the parameter update cycle. The end operation at block 628 may finalize logging records, release any temporary resources allocated during the update process, and signal completion status to dependent processes or monitoring systems. In some implementations, the end operation may trigger follow-up activities such as post-implementation verification processes, performance measurement to evaluate the effectiveness of the applied changes, or notifications to relevant stakeholders confirming successful completion of the configuration update. The end operation may also reset operational counters or timers used to track the frequency and duration of configuration processes, providing metrics that can be used to optimize the management framework itself. Upon completion of the configuration update sub-process 610, the system may return control to the main process flow described in FIG. 6A, potentially continuing to the termination point at block 612 or initiating another iteration of the optimization cycle.

Referring now to FIG. 6C, a flowchart illustrating a method 630 for autonomously adjusting wireless communication parameters in a data center environment using ‘machine-learning-based inference is depicted, in accordance with aspects of the present disclosure, at least some concepts of which have been discussed with reference to FIG. 1-6B. The method 630 may be performed by one or more control elements within the wireless communication control system 200 described with reference to FIG. 2A, such as the wireless performance monitoring module 206, machine-learning model 208, and wireless adjustment propagation module 212. In one aspect, method 630 can be implemented in one or more circuits. As may be appreciated, the one or more circuits may be included in the controller 202, the interconnect device 402 of FIG. 4, and/or correspond to or involve elements 204, 206, 208, 210, 212, 214, 216, and/or wireless adjustment logic module 424.

The method 630 begins at block 632, which represents a start condition for the parameter optimization process. The start condition at block 632 may be triggered through various mechanisms, including but not limited to: scheduled periodic execution according to predetermined time intervals (e.g., every 15 minutes, hourly, or daily); event-based triggers such as detection of performance degradation beyond defined thresholds; significant changes in network traffic patterns or workload distribution within the data center; addition or removal of hardware components that affect wireless signal propagation; or administrator-initiated optimization requests. In some implementations, the start condition may incorporate hysteresis mechanisms that prevent excessive reconfiguration by requiring performance metrics to remain outside acceptable ranges for a specified duration before triggering the optimization process. The start condition may also be associated with hierarchical priority classifications, where some performance degradations trigger immediate execution while minor optimizations may be deferred to low-utilization periods.

Method 630 then proceeds with receiving wireless performance parameters associated with communications between a plurality of data center components. In some aspects, the wireless performance parameters received at block 634 comprise quantitative measurements that characterize operational aspects of wireless links established between various data center elements, including but not limited to server-to-server connections, rack-to-rack communications, and interconnections between specialized components such as storage arrays and network switches. The parameters may include link quality metrics, and/or performance metrics. In some aspects, link quality metrics may include, but are not limited to signal-to-noise ratio (SNR) values that quantify the clarity of received signals relative to background noise; bit error rates (BER) that measure transmission reliability by calculating the proportion of incorrectly received bits; received signal strength indicators (RSSI) that quantify signal power at receiving antennas; and/or modulation error ratio (MER) values that assess signal quality in digital modulation schemes. The performance metrics may include, but are not limited to, throughput measurements expressed in bits per second, indicating actual data transfer rates achieved across wireless links; latency values measured in milliseconds, representing the time required for data to traverse the wireless path; jitter measurements that quantify timing variations in packet delivery; and/or packet loss statistics that identify instances where transmitted data fails to reach its destination. Additionally, the system may collect radio frequency (RF) environmental data including detected interference levels across utilized frequency bands; channel utilization percentages that indicate the proportion of available airtime consumed by active transmissions; spectral density measurements that characterize energy distribution across the frequency spectrum; and noise floor readings that establish baseline electromagnetic activity levels within the data center environment.

These wireless performance parameters may be collected through various mechanisms, including embedded telemetry agents operating within wireless transceivers, dedicated network monitoring appliances, specialized probe packets designed to measure specific performance aspects, or through management interfaces provided by wireless-enabled network infrastructure. The collection process may employ statistical techniques such as temporal averaging to reduce measurement noise, percentile analysis to identify performance outliers, and trend detection algorithms to identify gradual degradations before they impact operations. The collected parameters provide a comprehensive operational profile of the wireless communication environment, enabling subsequent analysis and optimization based on empirical observations rather than static rules or assumptions.

Method 630 then proceeds to block 636 with, inputting the wireless performance parameters into a machine-learning model trained to determine wireless parameter adjustments for a data center configuration. In some aspects, the machine-learning model referenced at block 636 may correspond to the machine-learning model 208 described with reference to FIG. 2A and the neural network 304 described with reference to FIG. 3B. The machine-learning model may have been previously trained using supervised learning techniques, where historical performance data paired with known optimal configurations provide labeled examples for the model to learn from. Alternatively, or in addition, the model may incorporate reinforcement learning paradigms where configuration recommendations are refined based on observed performance improvements resulting from previous adjustments. The training process may utilize diverse datasets encompassing various operational scenarios, workload patterns, environmental conditions, and hardware configurations to ensure robust generalization capabilities across different data center environments.

The method 630 may then proceed to block 638, with receiving, as output from the machine-learning model, one or more wireless communication adjustment parameters. In some aspects, the adjustment parameters generated at block 638 represent the machine-learning model's determination of optimal configuration settings based on current performance metrics and operational context. These parameters may constitute a comprehensive configuration profile for wireless links or targeted adjustments to specific aspects of wireless operation. The adjustment parameters may include modulation scheme selections that determine how information is encoded onto carrier signals, with higher-order schemes (e.g., 256-QAM, 1024-QAM) enabling greater data density under favorable signal conditions and lower-order schemes (e.g., QPSK, BPSK) providing improved reliability under challenging conditions. The parameters may specify frequency channel assignments that distribute communication across available spectrum to minimize interference, potentially including dynamic frequency selection (DFS) capabilities that avoid bands with detected radar or other primary users.

The adjustment parameters may further include transmit power settings that balance signal propagation range against energy consumption and interference potential; bandwidth allocations that determine the portion of the frequency spectrum assigned to different communication channels, with wider channels enabling higher throughput but consuming more spectral resources; spatial multiplexing configurations for MIMO (Multiple-Input Multiple-Output) implementations that utilize multiple antennas to increase capacity; beam steering directives that control the directionality of wireless transmissions for improved signal focus and reduced interference; guard interval settings that mitigate multipath effects in the data center environment; and forward error correction parameters that influence the trade-off between transmission efficiency and error resilience.

In addition to optimizing for communication performance, the machine-learning model may incorporate power efficiency as an optimization objective. The machine-learning model may integrate power consumption data collected from wireless transceivers, including instantaneous power draw measurements, cumulative energy usage statistics, and power efficiency metrics that relate data throughput to energy expenditure (measured in bits-per-joule). The power-related inputs may enable the machine-learning model to develop an understanding of the energy implications of different parameter configurations across various workload conditions. The machine-learning model may implement multi-objective optimization techniques that balance performance requirements against power consumption constraints, with configurable weighting factors that can be adjusted based on data center operational priorities, such as emphasizing energy efficiency during periods of high electricity costs or prioritizing performance during business operations.

In some aspects, the system implements several power-optimized parameter adjustment strategies based on workload classification and priority levels. For low-priority workloads such as background data transfers or routine backups, the model may recommend reducing transmission power by 3-6 dB below maximum levels while simultaneously shifting to lower-order modulation schemes (e.g., from 256-QAM to 16-QAM), resulting in power savings with minimal impact on operations. During periods of low utilization, the model may implement frequency consolidation, where multiple low-bandwidth communications are aggregated onto fewer frequency channels, allowing some transceivers to enter low-power states or be temporarily deactivated. In some aspects, the model may reduce power while maintaining performance by optimizing antenna beam patterns to achieve more focused energy delivery. The system may also implement dynamic duty cycling for intermittent communications, where transceivers alternate between active and sleep states according to traffic patterns.

The wireless communication system may balance performance needs against power consumption requirements. For example, performance metrics such as throughput, latency, and reliability may be evaluated alongside power efficiency metrics to generate configuration sets that represent possible compromises between performance and energy usage. The system may implement adaptive prioritization mechanisms that dynamically adjust the balance between performance and power efficiency based on workload characteristics, application-level requirements, time-of-day variations in electricity costs, and global data center power management directives. For example, during periods when the data center approaches power capping thresholds, the system may temporarily prioritize energy efficiency over maximum performance for non-critical workloads, while maintaining full performance for mission-critical applications through targeted resource allocation.

The wireless communication system may collect and analyze multiple power-related metrics to optimize energy efficiency across the wireless infrastructure. These metrics may include but are not limited to, energy-per-bit measurements that quantify the power required to successfully transmit one bit of data; power scaling efficiency curves that map transmission power levels to achievable data rates for different modulation schemes and channel conditions; spatial power distribution profiles that identify opportunities for more energy-efficient beam patterns; and/or component-level power states that track the energy consumption of individual subsystems within wireless transceivers. The system may maintain historical power consumption profiles correlated with workload patterns, enabling predictive power optimization strategies that anticipate future requirements.

Each adjustment parameter may be accompanied by metadata such as confidence scores indicating the model's certainty in its recommendations, expected performance improvements quantified through predicted metrics, dependency relationships between parameters that should be applied together, or implementation priorities that suggest the sequence in which changes should be applied. The adjustment parameters may represent a data-driven optimization strategy tailored to the specific conditions observed within the data center environment.

Method 630 may then proceed to block 640 with updating a configuration table with the one or more wireless communication adjustment parameters. In some aspects, the configuration table referenced at block 640 may correspond to the link configuration table 504 described with reference to FIG. 5B, which maps specific wireless links to their operational parameters. The update operation at block 640 may involve systematically modifying the stored parameter values associated with affected wireless links based on the machine-learning model's recommendations. The configuration table may be implemented using various data structures including relational database tables, key-value stores, structured configuration files, or distributed configuration management systems that ensure consistency across multiple network components.

Upon updating the configuration table, the system may trigger distribution mechanisms that propagate the new parameters to affected wireless devices within the data center. This propagation may occur through various channels including management protocols such as SNMP (Simple Network Management Protocol), NETCONF, or gRPC; configuration agents operating on network devices; software-defined networking controllers; or specialized wireless management interfaces. The distribution process may incorporate scheduling logic that determines when parameters should be applied based on operational considerations, with some adjustments implemented immediately while less urgent optimizations may be batched for efficiency or scheduled during maintenance windows. The method 630 terminates at block 642, which represents the completion of a single optimization cycle.

In some aspects of method 630, the wireless performance parameters comprise at least one of: signal-to-noise ratio; bit error rate; latency; throughput; or interference levels; and the one or more circuits are further to aggregate the wireless performance parameters from multiple wireless links within the data center.

In some aspects of method 630, the machine-learning model comprises a neural network trained on training data including wireless performance parameters specific to the data center configuration.

In some aspects of method 630, the one or more wireless communication adjustment parameters comprise at least one of: modulation scheme adjustments; frequency allocations; bandwidth allocations; transmission power levels; or beam steering parameters.

In some aspects of method 630, the modulation scheme adjustments comprise instructions to implement higher order modulation schemes for high priority workloads and lower order modulation schemes for low priority workloads, wherein the higher order modulation schemes comprise at least one of 64-QAM, 128-QAM, 256-QAM, 1024-QAM, 2048-QAM, or 4096-QAM, and wherein the lower order modulation schemes comprise at least one of QPSK, 8-QAM, or 16-QAM.

In some aspects of method 630, the one or more circuits are further to: receive workload information associated with the plurality of data center components; identify critical data traffic and non-critical data traffic based on the received workload information; and prioritize the critical data traffic over the non-critical data traffic based on periods of network congestion or to meet power consumption requirements.

In some aspects of method 630, the one or more circuits are further configured to: monitor workload conditions among the plurality of data center components, the workload conditions comprising at least one of traffic volume, processing utilization, or application priority data; identify workload priorities based on the monitored workload conditions; and adjust bandwidth allocations for one or more wireless links according to the identified workload priorities, wherein bandwidth for higher-priority workloads is increased and bandwidth for lower-priority workloads is decreased.

In some aspects of method 630, the configuration table comprises entries that map data center components to corresponding wireless communication adjustment parameters.

In some aspects of method 630, the one or more circuits are further to: distribute the configuration table to wireless transceivers within the data center; and cause the wireless transceivers to implement the one or more wireless communication adjustment parameters.

In some aspects of method 630, the machine-learning model is further configured to: determine interference patterns in the data center based on a physical layout of the plurality of data center components; and generate corresponding beamforming parameters for improving signal isolation.

In some aspects of method 630, the one or more circuits are further to: generate an interference metric for each transceiver by analyzing overlapping frequency bands; determine a beam steering angle for each transceiver; and update the configuration table with beamforming parameters that reduce interference across a wireless network of the data center.

In some aspects of method 630, the one or more circuits are further to maintain separate wireless communication adjustment parameters in the configuration table for different categories of data center traffic including at least two of: control and management traffic, data backup traffic, or real-time application traffic.

In some aspects of method 630, the plurality of data center components comprises: rack-mounted servers; storage devices; and wireless-enabled network switches.

In some aspects of method 630, the one or more circuits are further to: monitor communication patterns between data center component pairs; identify frequently communicating data center components; and adjust wireless communication adjustment parameters based on being identified as frequently communication data center components.

In some aspects of method 630, the configuration table maintains separate parameter settings for: pod-to-pod communications; rack-to-rack communications; and tray-to-tray communications within racks.

In some aspects of method 630, the one or more circuits are further to: detect changes in physical component locations; obtain updated wireless performance parameters based on the updated physical component locations; and propagate wireless communication adjustment parameters to one or more data center components.

In some aspects of method 630, the one or more circuits are further to: monitor the wireless performance parameters in real-time; and automatically adjust at least one of signal strength, frequency allocations, or modulation schemes for the plurality of wireless links based on the monitored wireless performance parameters.

Referring now to FIG. 6D, a flowchart illustrating a method 644 for workload analysis and prioritization in a wireless data center environment is depicted in accordance with aspects of the present disclosure, at least some concepts of which have been discussed with reference to FIG. 1-6C. The method 644 may be implemented by the wireless communication control system 200 described with reference to FIG. 2A and may relate to operations performed by the workload analysis circuit 228 described with reference to FIG. 2B. In some aspects, method 644 begins at block 646 with a start operation that initializes a workload analysis process. The start operation may be triggered by the receipt of new workload data, detection of significant changes in workload patterns, or as part of a scheduled analysis cycle that occurs at predetermined intervals to ensure continuous optimization of wireless resources.

Method 644 proceeds to block 648 with receiving wireless performance metrics from a plurality of wireless links between data center components in a data center. In some aspects, this operation may be performed by the monitoring interface 224 of FIG. 2B, which may correspond functionally to the wireless performance data collection component 204 of FIG. 2A. In implementations using the interconnect device 402 of FIG. 4B, this operation may involve the wireless ports 410a-410n collecting performance data through their associated queues 420a-420n and forwarding this information to the wireless adjustment logic module 424. The performance metrics may include, but are not limited to, signal-to-noise ratio measurements, throughput values, latency statistics, packet loss rates, and interference levels detected across operational wireless links.

Method 644 may proceed to block 650 with identifying different categories of data traffic based on workload characteristics. This categorization process may be performed by the workload analysis circuit 228 of FIG. 2B, with corresponding functionality implemented in the wireless performance monitoring module 206 of FIG. 2A. In implementations utilizing the hardware architecture of FIG. 4B, the wireless adjustment logic module 424 may perform this categorization with support from the processing circuitry 414. The system may classify traffic into distinct categories such as control and management traffic, data backup operations, real-time application data, or inter-process communication flows. Different traffic types ay be treated differently based on the traffic classification.

Method 644 may proceed to block 652 with determining priority levels for the different categories of data traffic. This priority determination may be performed by the workload analysis circuit 228 of FIG. 2B, with support from the wireless performance monitoring module 206 of FIG. 2A. In the hardware implementation of FIG. 4B, the wireless adjustment logic module 424 may execute this determination process. In some aspects, a system may assign priority designations such as “High,” “Medium,” or “Low,” based on factors including business criticality, service level agreements, and temporal sensitivity.

Method 644 may then proceed to block 654 with mapping the priority levels to wireless resource requirements. Such mapping process may be executed by the workload analysis circuit 228 of FIG. 2B. In some aspects, input may be provided from one or more of the wireless performance monitoring module 206 and the machine-learning model 208 of FIG. 2A. In the hardware architecture of FIG. 4B, the mapping function may be implemented within the wireless adjustment logic module 424. The mapping process may translate abstract priority designations into concrete resource allocations that can be implemented through configured wireless parameters such as bandwidth allocations, modulation schemes, and frequency assignments. In some aspects, method 644 proceeds to connector A 656, which serves as a transition point to subsequent processing steps detailed in FIG. 6E.

Referring now to FIG. 6E, a flowchart illustrating additional blocks of method 644 for wireless parameter determination and implementation is depicted in accordance with aspects of the present disclosure, at least some concepts of which have been discussed in accordance with aspects of the present disclosure. In some aspects, FIG. 6E continues the process initiated in FIG. 6D and may be implemented by the parameter engine 240 and distribution interface 242 described with reference to FIG. 2B, with corresponding functionality in components of the wireless communication control system 200 of FIG. 2A and the interconnect device 402 of FIG. 4B.

As depicted in FIG. 6E, method 644 may continue at connector A 656, which corresponds to the same connector shown at the conclusion of FIG. 6D. Method 644 may proceed to block 660 with analyzing the received wireless performance metrics and the wireless resource requirements. In some aspects, the analytical process may be performed by the parameter engine 240 of FIG. 2B, which may correspond functionally to the machine-learning model 208 of FIG. 2A. In implementations utilizing the hardware architecture of FIG. 4B, such analysis may be executed by the wireless adjustment logic module 424 with computational support from the processing circuitry 414. The analysis may incorporate various computational techniques to develop a comprehensive understanding of the relationship between current performance conditions and desired operational outcomes.

Method 644 may proceed to block 662, with determining wireless communication parameters for each wireless link of the plurality of wireless links based on the analysis of the received wireless performance metrics and the wireless resource requirements. In some aspects, all or part of block 662 may be executed by the parameter engine 240 of FIG. 2B, corresponding to functionality within the machine-learning model 208 of FIG. 2A. In the hardware implementation of FIG. 4B, the wireless adjustment logic module 424 may perform this determination with support from the processing circuitry 414. The determined parameters may include modulation scheme selections, frequency channel assignments, bandwidth allocations, transmission power settings, and beam steering directives tailored to the specific requirements of individual wireless links.

Method 644 may proceed to block 664, with generating implementation instructions for the wireless communication parameters. In some aspects, the instruction generation process may be performed by the parameter engine 240 of FIG. 2B, with support from the wireless configuration repository/configuration management module 210 of FIG. 2A. In the hardware implementation of FIG. 4B, the wireless adjustment logic module 424 may generate the implementation instructions with reference to configuration tables stored in memory 416. As described with reference to FIG. 2B, these implementation instructions 244 may include structured configuration directives formatted for consumption by wireless devices (and in some instances, wired devices) within the data center environment. The implementation instructions may translate abstract parameter values into device-specific commands, configuration profiles, or policy updates that can be directly applied to operational wireless systems.

The method 644 may proceed to block 666 with, transmitting the implementation instructions to wireless communication devices associated with the plurality of wireless links. In some aspects, the transmission may be performed by the distribution interface 242 of FIG. 2B, which may correspond functionally to the wireless adjustment propagation module 212 of FIG. 2A. In the hardware architecture of FIG. 4B, the processing circuitry 414 may coordinate this transmission, sending configuration commands through the appropriate wireless ports 410a-410n to target devices. The transmission may utilize secure management protocols, dedicated control channels, or software-defined networking interfaces to deliver the configuration directives to target devices.

Method 644 may conclude at block 668 with an end operation that finalizes the parameter determination and implementation cycle. The end operation may include logging completed configuration changes, updating system state records, or initiating post-implementation verification processes to confirm the effectiveness of the applied parameters. In some implementations, the end operation may trigger the beginning of a new optimization cycle, creating a continuous improvement loop that constantly adapts to changing conditions within the data center environment.

In view of the above, it should be appreciated that aspects of the present disclosure provide a system comprising a plurality of wireless communication interfaces to facilitate communications between a plurality of data center components; a performance monitoring module to receive wireless performance parameters associated with the communications between the plurality of data center components; a machine-learning model trained to determine wireless communication adjustment parameters for a data center configuration; and a configuration management module to update a configuration table with one or more wireless communication adjustment parameters received from the machine-learning model, wherein the plurality of wireless communication interfaces implement the wireless communication adjustment parameters based on the configuration table. In some aspects, the configuration management module is further to: detect changes in physical component locations within the data center; obtain updated wireless performance parameters based on distances between the plurality of data center components after the detected changes in physical component locations within the data center; and propagate updated wireless communication adjustment parameters to one or more of the plurality of data center components based on the updated wireless performance parameters. In some aspects, the machine-learning model is further to: analyze historical patterns of workload fluctuations in the data center; identify correlations between specific workload types and wireless communication parameters; and determine future wireless resource requirements based on scheduled workloads, wherein the configuration management module is further to preemptively update the configuration table based on the determined future wireless resource requirements before the scheduled workloads begin execution.

In view of the above, it should be appreciated that aspects of the present disclosure provide a device comprising: a monitoring interface to receive wireless performance metrics from a plurality of wireless links between data center components in a data center; a workload analysis circuit to: identify different categories of data traffic based on workload characteristics; determine priority levels for the different categories of data traffic; and map the priority levels to wireless resource requirements; a parameter engine to: analyze the received wireless performance metrics and the wireless resource requirements; determine wireless communication parameters for each wireless link of the plurality of wireless links based on the analysis of the received wireless performance metrics and the wireless resource requirements; and generate implementation instructions for the wireless communication parameters; and a distribution interface to transmit the implementation instructions to wireless communication devices associated with the plurality of wireless links.

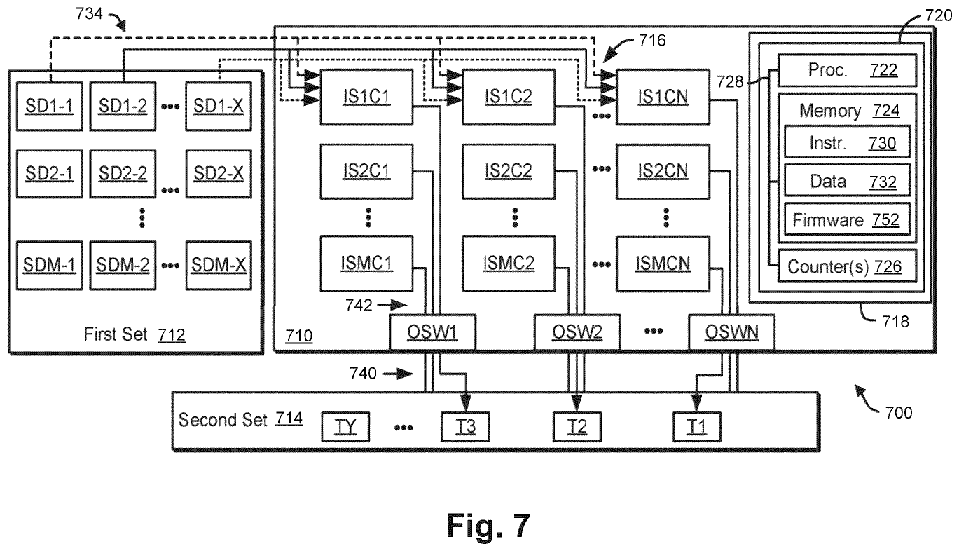

FIG. 7 illustrates a block diagram of a system 700 that includes switching circuitry 710 (sometimes referred to as a “fabric”) positioned between first and second sets 712 and 714 of devices, in accordance with at least one embodiment. By way of a non-limiting example, the system 700 may be implemented as a GPU-to-GPU link system (e.g., a NVLINK® GPU-to-GPU interconnect system) in which the switching circuitry 710 may include one or more GPU-to-GPU switches (e.g., one or more NVSWITCH™ switches). The system 700 may implement (e.g., be a component of) other systems, such as a data center, a cloud computing system, a machine learning system (e.g., utilizing one or more neural networks), an autonomous vehicle, medical imaging equipment, and/or the like.

Each of the first and second sets 712 and 714 may be implemented as a GPU, a parallel processing unit, a central processing unit (“CPU”), data processing unit (“DPU”), a controller, a switch, switching circuitry, a memory device, and/or the like. By way of a non-limiting example, the first set 712 has been illustrated as including a number “M*X” of devices, which are illustrated as devices SD1-1 to SDM-X. However, the set 712 may include any number of devices including a single device. For ease of illustration, in FIG. 7, the devices SD1-1 to SDM-X have been illustrated as being arranged in a two-dimensional array that includes a number “M” of rows and a number “X” of columns. The second set 714 has been illustrated as including a number “Y” of devices, which are illustrated as devices T1-TY, but the second set 714 may include any number of devices including a single device. Further, one or more devices may be members of both of the sets 712 and 714. Thus, the sets 712 and 714 are not mutually exclusive and may include one or more of the same devices. Therefore, in at least one embodiment, the switching circuitry 710 may allow any of the devices SD1-1 to SDM-X in the first set 712 to communicate with any of the devices SD1-1 to SDM-X in the first set 712 and/or any of the devices T1-TY in the second set 714. Further, in at least one embodiment, the switching circuitry 710 may allow any of the devices T1-TY in the second set 714 to communicate with any of the devices T1-TY in the second set 714 and/or any of the devices SD1-1 to SDM-X in the first set 712.

The switching circuitry 710 may include a number “N” of outbound switches OSW1-OSWN, a predetermined number “M*N” of internal switches IS1C1-ISMCN, signal conductors 716, and a route block 718 that controls the operations of the internal switches IS1C1-ISMCN. The route block 718 has been illustrated as including hardware 720 that may include at least one processor 722, memory 724, and one or more counters 726. In at least one embodiment, each of the processor(s) 722 may be implemented as one or more hardware state machines, one or more microprocessors, one or more microcontrollers, one or more controllers, or the like. The memory 724 (e.g., one or more non-transitory processor-readable medium) may be implemented, for example, using volatile memory (e.g., dynamic random-access memory (“DRAM”)) and/or nonvolatile memory (e.g., a hard drive, a solid state device (“SSD”), and/or the like).

The signal conductors 716 interconnect the first set 712, the second set 714, the internal switches IS1C1-ISMCN, and the outbound switches OSW1-OSWN. In the example illustrated, the signal conductors 716 may include any number of signal conductors. The signal conductors 716 may each be implemented as a wire, a trace, and/or any other type of electrical conductor. As a non-limiting example, one or more of the signal conductors 716 may each be implemented as a wire-based serial near-range communications link. By way of another non-limiting example, one or more of the signal conductors 716 may each be implemented as a Scalable Link Interface (“SLI”).

In the embodiment illustrated, the signal conductors 716 include signal conductors 734, 740, and 742. The signal conductors 734 connect the devices SD1-1 to SDM-X to the internal switches IS1C1-ISMCN. For ease of illustration, only those of the signal conductors 734 that connect each of the devices SD1-1 to SD1-X to the internal switches IS1C1-IS1CN have been illustrated in FIG. 7. In at least one embodiment, the internal switches IS1C1-IS1CN may each include a different port that is connected to each of at least a portion of the devices SD1-1 to SDM-X (e.g., the devices SD1-1 to SD1-X, respectively) by the signal conductors 734. Similarly, the internal switches IS2C1-IS2CN may each include a different internal port that is connected to each of at least a portion of the devices SD1-1 to SDM-X (e.g., the devices SD2-1 to SD2-X, respectively) by the signal conductors 734. Further, the internal switches ISMC1-ISMCN may each include a different internal port that is connected to each of at least a portion of the devices SD1-1 to SDM-X (e.g., the devices SDM-1 to SDM-X, respectively) by the signal conductors 734.

The signal conductors 742 connect the internal switches IS1C1-ISMCN to the outbound switches OSW1-OSWN. For example, at least one of the signal conductors 742 connects each of the internal switches IS1C1-ISMC1 to the outbound switch OSW1, at least one of the signal conductors 742 connects each of the internal switches IS1C2-ISMC2 to the outbound switch OSW2, and at least one of the signal conductors 742 connects each of the internal switches IS1CN-ISMCN to the outbound switch OSWN.

The signal conductors 740 connect the outbound switches OSW1-OSWN to the devices T1-TY. The outbound switches OSW1-OSWN may each include a different port that is connected by at least one of signal conductors 740 to at least one of the devices T1-TY.

While the switching circuitry 710 has been illustrated as including the internal switches IS1C1-ISMCN, the switching circuitry 710 may include any number of internal switches including a single internal switch. Further, the internal switches IS1C1-ISMCN have been illustrated as being arranged in a two-dimensional array that includes the number “M” of rows and the number “N” of columns. However, this is not a requirement and the internal switches IS1C1-ISMCN may positioned in alternate arrangements to implement any network topology, including a three-dimensional array. One or more of the internal switches IS1C1-ISMCN may be coupled to one another. For example, from the perspective of one of the internal switches IS1C1-ISMCN, one or more of the other internal switches IS1C1-ISMCN may be one of the devices T1-TY. Further, the switching circuitry 710 may be coupled to one or more switches (e.g., switching circuitry like the switching circuitry 710) that is/are external to the switching circuitry 710. For example, one or more of the devices SD1-1 to SDM-X and/or the devices T1-TY may each be implemented as an external switch.

The route block 718 may be connected to each of the internal switches IS1C1-ISMCN and/or each of at least a portion of the signal conductors 716 by one or more buses. For example, the processor(s) 722 and the memory 724 may be connected to one another by one or more buses 728. The bus(es) 728 may also connect the processor(s) 722 and the memory 724 to the internal switches IS1C1-ISMCN and/or each of at least a portion of the signal conductors 716. The memory 724 (e.g., a non-transitory processor readable media) stores instructions 730 that are executable by the processor(s) 722, data 732, and firmware 752, which may perform monitoring and data manipulation functions. For example, the firmware 752 may instruct the hardware 720 to transition one or more of the signal conductors 716, from the active state to the inactive state and vice versa.

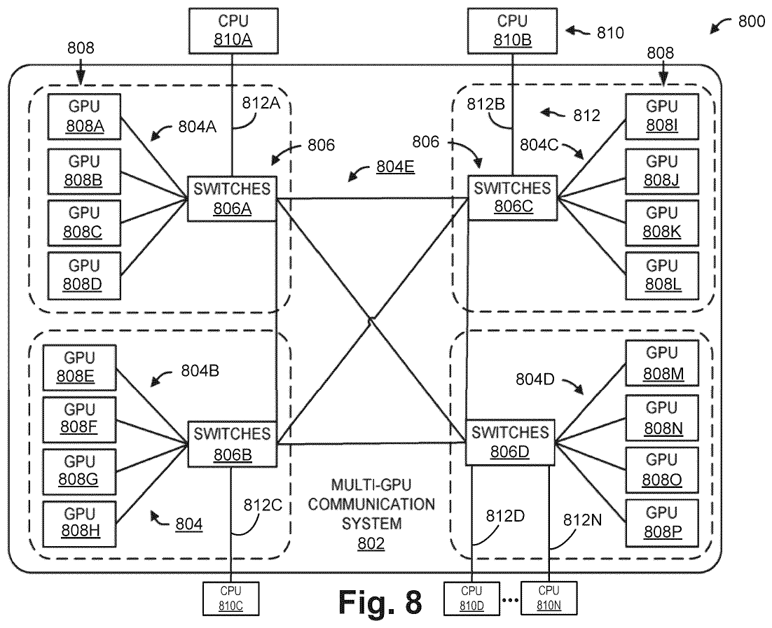

FIG. 8 illustrates a block diagram of an example system 800, in accordance with at least one embodiment. The system 800 may include, in at least one embodiment, one or more CPUs 810 connected to one or more multi-GPU communication systems (e.g., a multi-GPU communication system 802) by one or more signal conductors 812. In the embodiment illustrated in FIG. 8, the CPU(s) 810 include CPUs 810A, 810B, 810C, and 810D, which are connected to the multi-GPU communication system 802 by signal conductors 812A, 812B, 812C, and 812D, respectively. In some aspects, zero, one, or more CPUs (e.g., 810N) may be in communication with a switch (e.g., 806D) via one or more signal conductors 812N). In FIG. 8, the multi-GPU communication system 802 includes GPUs 808 connected to one another by at least one switch 806 and at least one signal conductor 804. In the embodiment illustrated, the switch(es) 806 include switches 806A-806D, the GPUs 808 include GPUs 808A-208P, and the signal conductor(s) 804 include signal conductors 804A-804E.

The system 800 may be characterized as being an example implementation of the system 700 (see FIG. 7). For example, the CPU(s) 810 and/or the GPUs 808 may be implementations of the set 712 and/or the set 714. In at least one embodiment, the CPU(s) 810 may be substantially identical to the devices SD1-1 to SDM-X and/or the devices T1-TY. In at least one embodiment, the GPUs 808 may be substantially identical to the devices SD1-1 to SDM-X and/or the devices T1-TY. By way of another non-limiting example, the signal conductor(s) 804 and/or the signal conductor(s) 812 may be implementations of the signal conductors 716. In at least one embodiment, the signal conductor(s) 804 and/or the signal conductor(s) 812 may be substantially identical to the signal conductors 716. By way of yet another non-limiting example, the switch(es) 806 may be implementations of the internal switches IS1C1-ISMCN and/or the outbound switches OSW1-OSWN. In at least one embodiment, the switch(es) 806 may be substantially identical to the switches IS1C1-ISMCN (see FIG. 7) and/or the outbound switches OSW1-OSWN.

As a non-limiting example, the signal conductors 804 may link the GPUs 808 to the switch(es) 806, and the signal conductors 812A and 812B may link the at least one of the switch(es) 806 to one or more of the CPU(s) 810. As illustrated in FIG. 8, the CPUs 810A and 810B may connected to the switches 806A and 806C, respectively, by the signal conductors 812A and 812B, respectively. In at least one embodiment, one or more of the CPU(s) 810 may be implemented as a CPU 1600 illustrated in FIG. 16. One or more of the GPUs 808 may be implemented as one or more parallel processor(s) 1412 illustrated in FIG. 14.

The multi-GPU communication system 802 may implement a form of mesh networking, which may have a local area network topology in which infrastructure nodes or devices may be connected directly, dynamically, and non-hierarchically to other nodes and may cooperate with one another to efficiently route data. Examples of infrastructure devices may include bridges, the switch(es) 806, and/or other types of infrastructure devices. The multi-GPU communication system 802 may be referred to as a GPU-to-GPU System. By way of a non-limiting example, the multi-GPU communication system 802 may be implemented as a GPU-to-GPU link system (e.g., a NVLINK® GPU-to-GPU interconnect system) in which the switch(es) 806 may include one or more GPU-to-GPU switches (e.g., one or more NVSWITCH™ switches).

The switch 806A is connected to the GPUs 808A-208D by the signal conductors 804A, the switch 806B is connected to the GPUs 808E-808H by the signal conductors 804B, the switch 806C is connected to the GPUs 808I-808L by the signal conductors 804C, and the switch 806D is connected to the GPUs 808M-808P by the signal conductors 804D. The switches 806A-806D are connected to one another by signal conductors 804E. Each of the switch(es) 806 may act as a router and/or a connection between two endpoints within the system 800 for the duration of a dedicated connection. In at least one embodiment, one or more of the switch(es) 806 may be implemented using an on-node switch architecture (e.g., one or more NVSWITCH™ switches) that connects processing units (e.g., one or more GPUs, one or more CPUs, and/or one or more other types of processor) together. The system 800 may function as part of another system, such as a data center, which incorporates hardware, networking, software, and/or libraries, and executes applications, such applications perform inferences, for example by executing Artificial Intelligence (“AI”) or machine learning models.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. The systems and methods described herein may be used in augmented reality, virtual reality, mixed reality, robotics, security and surveillance, autonomous or semi-autonomous machine applications, and/or any other technology spaces in which one or more signal conductors may have at least two different states that consume different amounts of power.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, web-hosted services or web-hosted platforms, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for implementing web-hosted services (e.g., for program optimization at runtime) or web-hosted platforms (e.g., integrated development environments that include program optimization as a service), as an application programming interface (“API”) between two or more separate applications or systems, and/or other types of systems.

### Data Center

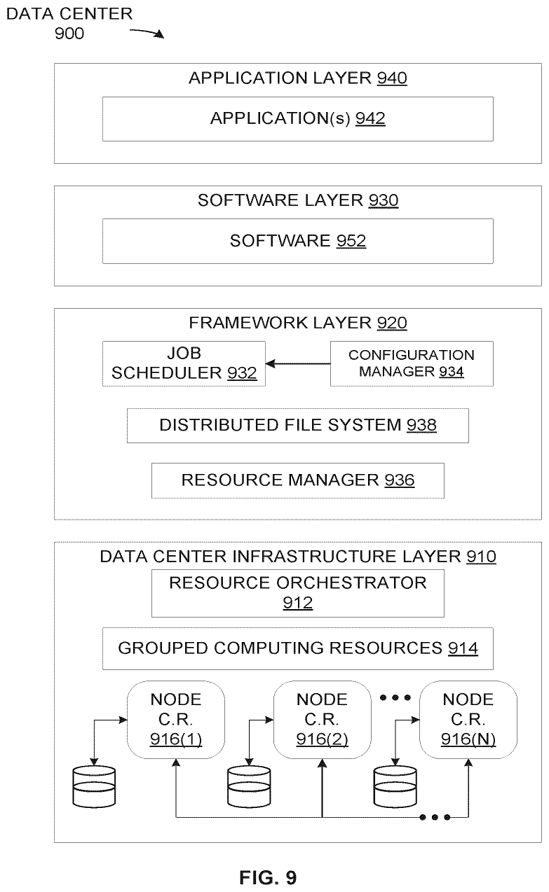

FIG. 9 illustrates an example data center 900, in accordance with at least one embodiment. In at least one embodiment, data center 900 includes, without limitation, a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (“FPGAs”), data processing units (“DPUs”) in network devices, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R. s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-916(N) and/or grouped computing resources 914. In at least one embodiment, resource orchestrator 912 may include a software design infrastructure (“SDI”) management entity for data center 900. In at least one embodiment, resource orchestrator 912 may include hardware, software or some combination thereof.

In at least one embodiment, as shown in FIG. 9, framework layer 920 includes, without limitation, a job scheduler 932, a configuration manager 934, a resource manager 936 and a distributed file system 938. In at least one embodiment, framework layer 920 may include a framework to support software 952 of software layer 930 and/or one or more application(s) 942 of application layer 940. In at least one embodiment, software 952 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920, including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 952 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. In at least one or more types of applications may include, without limitation, CUDA applications.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, the data center 900 may be used to implement the system 700 (see FIG. 7) and/or the system 800 (see FIG. 8). For example, the first set 712 and/or the second set 714 may include one or more of the grouped computing resources 914 and/or one or more of the C.R.s 916(1)-916(N). In at least one embodiment, one or more systems depicted in FIG. 9 are utilized to implement one or more systems and/or processes such as those described in connection with FIGS. 1-8.

It should be noted that, while example embodiments described herein may relate to a CUDA programming model, techniques described herein can be utilized with any suitable programming model, such HIP, oneAPI (e.g., using oneAPI-based programming to perform or implement a method disclosed herein), and/or variations thereof.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art. It is to be appreciated that any feature described herein can be claimed in combination with any other feature(s) as described herein, regardless of whether the features come from the same described embodiment.

What is claimed is:

1. An apparatus comprising:
one or more circuits to:
receive wireless performance parameters associated with communications between a plurality of data center components;
input the wireless performance parameters into a machine-learning model trained to determine wireless parameter adjustments for a data center configuration;
receive, as output from the machine-learning model, one or more wireless communication adjustment parameters; and
update a configuration table with the one or more wireless communication adjustment parameters.

2. The apparatus of claim 1, wherein the wireless performance parameters comprise at least one of:
signal-to-noise ratio;
bit error rate;
latency;
throughput; or
interference levels; and
wherein the one or more circuits are further to aggregate the wireless performance parameters from multiple wireless links within the data center.

3. The apparatus of claim 2, wherein the machine-learning model comprises a neural network trained on training data including wireless performance parameters specific to the data center configuration.

4. The apparatus of claim 1, wherein the one or more wireless communication adjustment parameters comprise at least one of:
modulation scheme adjustments;
frequency allocations;
bandwidth allocations;
transmission power levels; or
beam steering parameters.

5. The apparatus of claim 4, wherein the modulation scheme adjustments comprise instructions to implement higher order modulation schemes for high priority workloads and lower order modulation schemes for low priority workloads, wherein the higher order modulation schemes comprise at least one of 64-QAM, 128-QAM, 256-QAM, 1024-QAM, 2048-QAM, or 4096-QAM, and wherein the lower order modulation schemes comprise at least one of QPSK, 8-QAM, or 16-QAM.

6. The apparatus of claim 1, wherein the one or more circuits are further to:
receive workload information associated with the plurality of data center components;
identify critical data traffic and non-critical data traffic based on the received workload information; and
prioritize the critical data traffic over the non-critical data traffic based on periods of network congestion or to meet power consumption requirements.

7. The apparatus of claim 1, wherein the one or more circuits are further configured to:
monitor workload conditions among the plurality of data center components, the workload conditions comprising at least one of traffic volume, processing utilization, or application priority data;
identify workload priorities based on the monitored workload conditions; and
adjust bandwidth allocations for one or more wireless links according to the identified workload priorities, wherein bandwidth for higher-priority workloads is increased and bandwidth for lower-priority workloads is decreased.

8. The apparatus of claim 1, wherein the configuration table comprises entries that map data center components to corresponding wireless communication adjustment parameters.

9. The apparatus of claim 1, wherein the one or more circuits are further to:
distribute the configuration table to wireless transceivers within the data center; and
cause the wireless transceivers to implement the one or more wireless communication adjustment parameters.

10. The apparatus of claim 1, wherein the machine-learning model is further configured to:
determine interference patterns in the data center based on a physical layout of the plurality of data center components; and
generate corresponding beamforming parameters for improving signal isolation.

11. The apparatus of claim 10, wherein the one or more circuits are further to:
generate an interference metric for each transceiver by analyzing overlapping frequency bands;
determine a beam steering angle for each transceiver; and
update the configuration table with beamforming parameters that reduce interference across a wireless network of the data center.

12. The apparatus of claim 1, wherein the one or more circuits are further to maintain separate wireless communication adjustment parameters in the configuration table for different categories of data center traffic including at least two of: control and management traffic, data backup traffic, or real-time application traffic.

13. The apparatus of claim 1, wherein the plurality of data center components comprises:
rack-mounted servers;
storage devices; and
wireless-enabled network switches.

14. The apparatus of claim 13, wherein the one or more circuits are further to:
monitor communication patterns between data center component pairs;
identify frequently communicating data center components; and
adjust wireless communication adjustment parameters based on being identified as frequently communication data center components.

15. The apparatus of claim 1, wherein the configuration table maintains separate parameter settings for:
pod-to-pod communications;
rack-to-rack communications; and
tray-to-tray communications within racks.

16. The apparatus of claim 1, wherein the one or more circuits are further to:
detect changes in physical component locations;
obtain updated wireless performance parameters based on the updated physical component locations; and
propagate wireless communication adjustment parameters to one or more data center components.

17. The apparatus of claim 1, wherein the one or more circuits are further to:
monitor the wireless performance parameters in real-time; and
automatically adjust at least one of signal strength, frequency allocations, or modulation schemes for one or more wireless links based on the monitored wireless performance parameters.

18. A system comprising:
a plurality of wireless communication interfaces to facilitate communications between a plurality of data center components;
a performance monitoring module to receive wireless performance parameters associated with the communications between the plurality of data center components;
a machine-learning model trained to determine wireless communication adjustment parameters for a data center configuration; and
a configuration management module to update a configuration table with one or more wireless communication adjustment parameters received from the machine-learning model, wherein the plurality of wireless communication interfaces implements the wireless communication adjustment parameters based on the configuration table.

19. The system of claim 18, wherein the configuration management module is further to:
detect changes in physical component locations within the data center;
obtain updated wireless performance parameters based on distances between the plurality of data center components after the detected changes in physical component locations within the data center; and
propagate updated wireless communication adjustment parameters to one or more of the plurality of data center components based on the updated wireless performance parameters.

20. The system of claim 18, wherein the machine-learning model is further to:
analyze historical patterns of workload fluctuations in the data center;
identify correlations between specific workload types and wireless communication parameters; and
determine future wireless resource requirements based on scheduled workloads, wherein the configuration management module is further to preemptively update the configuration table based on the determined future wireless resource requirements before the scheduled workloads begin execution.

21. A device comprising:
a monitoring interface to receive wireless performance metrics from a plurality of wireless links between data center components in a data center;
a workload analysis circuit to:
identify different categories of data traffic based on workload characteristics;
determine priority levels for the different categories of data traffic; and
map the priority levels to wireless resource requirements;
a parameter engine to:
analyze the received wireless performance metrics and the wireless resource requirements;
determine wireless communication parameters for each wireless link of the plurality of wireless links based on the analysis of the received wireless performance metrics and the wireless resource requirements; and
generate implementation instructions for the wireless communication parameters; and
a distribution interface to transmit the implementation instructions to wireless communication devices associated with the plurality of wireless links.
